(19) United States
(12) Patent Application Publication
(10) Pub. No.: US 2018/0275260 A1
(43) Pub. Date: Sep. 27, 2018

(54) Classifying One or a Plurality of Reflection Objects

(71) Applicants: Volker Mathis Lücken, Aachen (DE); Nils Voss, Aachen (DE)

(72) Inventors: Volker Mathis Lücken, Aachen (DE); Nils Voss, Aachen (DE)

(73) Assignee: ICE Gateway GmbH, Berlin (DE)

(21) Appl. No.: 15/989,998

(22) Filed: May 25, 2018

Related U.S. Application Data
(63) Continuation of application No. PCT/EP2016/078855, filed on Nov. 25, 2016.

(30) Foreign Application Priority Data
Nov. 27, 2015 (DE) 10 2015 120 659.5

(51) Int. Cl. G01S 7/539; G01S 15/89; G01S 15/06

(52) U.S. Cl. CPC G01S 7/539; G08G 1/0116; G01S 15/06; G01S 15/89

(57) ABSTRACT

A method is disclosed in which ultrasonic echo signal data is obtained. The ultrasonic echo signal data includes a plurality of data points. The ultrasonic echo signal data at least partly represents an ultrasonic echo signal detected by an ultrasonic sensor, and the ultrasonic echo signal includes signal portions tracing back to reflections on one or a plurality of reflection objects. A plurality of data points of the ultrasonic echo signal data are grouped into one or a plurality of data point clusters. Characteristic data is determined at least partly as a function of a data point and/or a plurality of data points of a data point cluster of the ultrasonic echo signal data. One or a plurality of the reflection objects are classified at least partly based on the characteristic data obtained as a result of the determination.

### CROSS-REFERENCE TO RELATED PATENT APPLICATIONS

This patent application is a continuation of PCT/EP2016/078855, filed Nov. 25, 2016, which claims priority to German Application No. 10 2015 120 659.5, filed Nov. 27, 2015, the entire teachings and disclosure of which are incorporated herein by reference thereto.

### FIELD

Exemplary embodiments of the invention relate to classifying one or a plurality of reflection objects in the detection range of an ultrasonic sensor.

### BACKGROUND

Different systems are known for detecting moving and unmoving objects, for example for traffic monitoring. These systems often have stationary imaging sensors, infra-red sensors and radar sensors or a combination of these types of sensors. The use of radar sensors is expensive and complicated due to the complexity of the technology. Infra-red sensors may be disrupted by environmental light and by high environmental temperatures such that optimal results cannot exactly be achieved in an application outdoors. The use of imaging sensors is often problematic with systems outdoors for reasons of privacy law and requires high computing power in order to evaluate the sensor data. The common advantage of all the previously described methods is that they are all non-intrusive which means that the sensors do not have to be incorporated in the road surface. Intrusive sensors, such as for example induction loops, have good detection rates. The installation is, however, associated with high complexity and interference with road transport.

Ultrasonic sensors, like further non-intrusive sensors, have been used in road transport hitherto primarily in parking assistance systems of vehicles for distance measurement. In this case, it is only evaluated whether and at what distance an emitted ultrasonic pulse is initially reflected. Such evaluations of the initial reflection are, however, not sufficient for precisely detecting moving and unmoving objects as well as for classifying the objects, if other objects are also present in the detection range. Ultrasonic sensors are particularly sensitive to disruptions and changes in the environments covered by the ultrasonic sensors, such as for example base reflections of the environment, the ground and stationary objects as well as movement of tree branches by the wind and similar. Ultrasonic sensors have thus not been used hitherto in systems for detecting moving and unmoving objects in a complex environment.

### SUMMARY OF SOME EXEMPLARY EMBODIMENTS OF THE INVENTION

The present invention thus has the object, inter alia, of overcoming these problems.

According to the invention, a method is disclosed, the method comprises:
obtaining ultrasonic echo signal data, wherein the ultrasonic echo signal data comprises a plurality of data points, wherein the ultrasonic echo signal data at least partly represents an ultrasonic echo signal detected by an ultrasonic sensor and wherein the ultrasonic echo signal comprises signal portions tracing back to reflections on one or a plurality of reflection objects,
grouping a plurality of data points of the ultrasonic echo signal data into one or a plurality of data point clusters,
determining characteristic data at least partly as a function of a data point and/or a plurality of data points of a data point cluster of the ultrasonic echo signal data,
classifying one or a plurality of the reflection objects at least partly based on the characteristic data obtained as a result of the determination.

The method according to the invention and/or the steps of the method according to the invention are mentioned as an example of a apparatus like the apparatus according to the invention described below. Alternatively, it is also possible for the method according to the invention and/or the steps of the method according to the invention to be performed by different apparatuses of a system, like the system according to the invention described below.

According to the invention, a computer program is also disclosed, the computer program comprises program instructions, which cause a processor to execute and/or control the method according to the invention when the computer program runs on the processor.

The computer program according to the invention may, for example, be distributable via a network such as the internet, smart city infrastructure as well as smart building solutions such as the ICE Gateway distributed by the company, ICE Gateway GmbH, other open source solutions such as Raspberry PI, a telephone or mobile telephone network and/or a local network. The computer program according to the invention can be at least partly software and/or firmware of a processor and/or software and/or firmware of an embedded system. It may be implemented at least partly in the same manner as hardware. The computer program according to the invention can, for example be stored on a computer-readable memory medium, e.g. a tangible, magnetic, electric, electromagnetic, optical and/or other type of memory medium. The memory medium can, for example, be part of the processor, for example a (non-volatile or volatile) program memory and/or main memory of the processor or a part thereof.

According to the invention, a apparatus is also disclosed, the apparatus comprises:
means configured to perform and/or control the method according to the invention or means to perform and/or control the steps of the method according to the invention.

For example, the means of the apparatus according to the invention are configured to perform and/or control the method according to the invention or its steps (e.g. aside from the steps performed by a user). One or a plurality of the steps of the method according to the invention can also be performed and/or controlled by the same means. For example, one or a plurality of the means of the invention can be formed at least partly by one or a plurality of processors.

For example, the apparatus according to the invention has at least one circuit which is configured to prompt the apparatus to perform and/or control at least the method according to the invention and/or the steps of the method according to the invention. In this case, either all steps of the method according to the invention can be controlled, or all steps of the method according to the invention can be performed, or one or a plurality of the steps can be controlled and one or a plurality of steps can be performed.

A circuit should be understood in the present case for example as an implementation of the means of the apparatus according to the invention only in hardware and/or an implementation of the means of the apparatus according to the invention with a combination of hardware and software.

Implementation of the means of the apparatus according to the invention only in hardware comprises, for example, digital and/or analogue circuits (e.g. exclusively digital and/or analogue circuits) such as a configurable digital logic. For example, the apparatus according to the invention comprises at least one digital and/or analogue circuit which is configured to prompt the apparatus to perform and/or control at least the method according to the invention and/or the steps of the method according to the invention.

Implementation of the means of the apparatus according to the invention with a combination of hardware and software comprises, for example, at least one processor and at least one memory with program instructions. For example, the apparatus according to the invention has a processor and at least one memory, which contains program code, wherein the memory and the program code are configured to prompt the apparatus together with at least one processor, to perform and/or control at least the method according to the invention and/or the steps of the method according to the invention. A processor should, for example, be understood as a control unit, a microprocessor, a microcontrol unit such as a microcontroller, a digital signal processor (DSP, Digital Signal Processor), an application-specific integrated circuit (ASIC, Application-Specific Integrated Circuit) or a Field Programmable Gate Array, FPGA).

According to the invention, a system is also disclosed, the system comprises:
one or a plurality of apparatuses according to the invention, and
one or a plurality of stationary ultrasonic sensors.

The properties of the method according to the invention, of the computer program according to the invention, of the apparatus according to the invention and of the system according to the invention are, partly by way of example, described below.

An ultrasonic echo signal should, for example, be understood as an ultrasonic signal which is detected by an ultrasonic sensor and at least substantially comprises signal portions tracing back to reflections on one or a plurality of reflection objects. In this case, a reflection object is, for example, understood as an object in the detection range of the ultrasonic sensor on which an ultrasonic signal (e.g. one or a plurality of ultrasonic pulses) is reflected. A reflection object can, for example, be a moving object (i.e. a moving reflection object) or an unmoving object (i.e. an unmoving reflection object). The detection range of the ultrasonic sensor is, for example, the spatial range that can be monitored by the ultrasonic sensor in the environment of the ultrasonic sensor (e.g. the spatial range in which signal portions tracing back to reflections on one or a plurality of reflection objects in the direction of the ultrasonic sensor are detectable by the ultrasonic sensor).

The ultrasonic echo signal is detected by the ultrasonic sensor, for example by measuring the signal strength of the ultrasonic echo signal. For example, the ultrasonic sensor is formed as an ultrasonic detector. For example, the signal strength of an ultrasonic echo signal detectable at the position of the ultrasonic sensor can be detected and/or measured indirectly by a piezoelectric transducer encompassed by the ultrasonic sensor. For example, the piezoelectric transducer converts the ultrasonic echo signal into an electric signal. For example, the value of the signal strength of the ultrasonic echo signal can be determined by the measurement of the voltage amplitude of this electric signal. The ultrasonic echo signal data can, for example, be obtained by an analogue-digital converter of this electric signal.

The ultrasonic echo signal data are, for example, a representation of the time curve of the signal strength of the ultrasonic echo signal detected by the ultrasonic sensor. The ultrasonic echo signal data are preferably a digital representation of the time curve of the signal strength of the ultrasonic echo signal detected by the ultrasonic sensor. The signal strength corresponds, for example, to the signal energy of the detected ultrasonic echo signal.

A data point of the ultrasonic echo signal data comprises, for example, a representation (e.g. a digital representation) of the value of the signal strength of the ultrasonic echo signal detected by the ultrasonic sensor at a determined detection time. Such a data point can, for example, also comprise a representation (e.g. a digital representation) of the detection time. Alternatively or additionally, the detection time can also emerge from the position of the data point in the ultrasonic echo signal data. In addition, a data point of the ultrasonic echo signal data can optionally comprise further additional information such as frequency and/or phase information (e.g. the frequency spectrum per data point and/or the phase position per data point).

Obtaining the ultrasonic echo signal data comprises, for example, measuring the signal strength of the ultrasonic echo signal and/or determining the value of the signal strength or further information of the ultrasonic echo signal. In this case, the ultrasonic sensor is, for example, a part of the apparatus according to the invention.

Alternatively or additionally, obtaining the ultrasonic echo signal data can also comprise obtaining the ultrasonic echo signal data from the ultrasonic sensor. In this case, the ultrasonic sensor is, for example, not part of the apparatus according to the invention. In this case, the ultrasonic echo signal data are, for example, communicated from the ultrasonic sensor to the apparatus according to the invention. For example, the apparatus according to the invention comprises communication means which are configured to obtain the ultrasonic echo signal data from the ultrasonic sensor.

An example of such communication means is a communication interface, for example a wireless communication interface such as a communication interface of wireless communication technology or a wired communication interface such as a communication interface of wired communication technology. An example of wireless communication technology is Zigbee, 6LOWPAN, a local radio network such as Radio Frequency Identification (RFID) and/or Near Field Communication (NFC) and/or Bluetooth (e.g. Bluetooth Version 2.1 and/or 4.0) and/or Wireless Local Area Network (WLAN). RFID and NFC—are, for example, specified according to the ISO-Standards 18000, 11784/11785 and the ISO/IEC-Standard 14443-A and 15693. The Bluetooth specifications are currently available on the internet at www[dot]Bluetooth[dot]org. WLAN is specified for example in the standards of IEEE-802.11 family. A further example of wireless communication technology is regional radio technology such as for example a mobile network, for example, Global System for Mobile Communications (GSM) and/or Universal Mobile Telecommunications System (UMTS) and/or Long Term Evolution (LTE). GMS, UMTS and LTE specifications are supported and developed by the 3rd Generation Partnership Project (3GPP) and are currently available on the internet at www[dot]3gpp[dot]com. An example of wired communication technology is, for example, Ethernet, USB (Universal Serial Bus), Firewire, UART (Universal Asynchronous Receiver Transmitter) such as RS-232, SPI (Serial Peripheral Interface) and/or I2C (Inter-Integrated Circuit). The USB specifications are currently available on the internet at www[dot]usb[dot]org. A wired Ethernet communication interface could, at the same time, also be used for the energy supply of the apparatus according to the invention and/or the ultrasonic sensor in the context of technology designated as PoE (Power over Ethernet). PoE is, for example, specified in the IEEE-Standard 802.3af-2003. However, later and future versions of this standard or proprietary modifications should also be understood under the term PoE. PoE can, for example, be used both for the energy supply of the apparatus according to the invention and/or of the ultrasonic sensor and also as communication technology for communicating information and/or data between the apparatus according to the invention and the ultrasonic sensor. In this case, various communication protocols such as for example CoAP (Constrained Application Protocol) can be used. CoAP is a communication protocol of the application layer specified inter alia in the RFC 7252 of the IETF (Internet Engineering Task Force).

A data point cluster should, for example, be understood as a group of data points. For example, the data points of a data point cluster are similar. For example, data points are grouped into a data point cluster if one or a plurality of properties of the data points (e.g. the positions of the data points inside the ultrasonic echo signal data) and/or the values of the signal strength represented by the data points and/or the detection time represented by the data points are inside a range of similarity (e.g. a predefined range of similarity). Grouping a plurality of data points of the ultrasonic echo signal data into one or a plurality of data point clusters can, in particular, comprise applying a cluster algorithm to the data points of the ultrasonic echo signal data. By selecting a suitable range of similarity and/or a suitable clustering algorithm, data points are, for example, grouped into one or a plurality of data point clusters which at least substantially represent signal portions of the ultrasonic echo signal tracing back to reflections on a determined reflection object. A distinction is thereby possible from signal portions of the ultrasonic echo signal tracing back at least substantially to reflections on different reflection objects.

Characteristic data of the respective data point cluster can then be determined.

The characteristic data describe, for example, characteristic properties of the data point clusters and/or comprise characteristic values of the data point clusters. Examples of such properties and characteristic values are the localisation, distribution, form, morphology, sample and expansion of a data point cluster. Further examples for this are the reflection energy and signal runtime of the signal portion, (e.g. at least substantially tracing back to reflections on a reflection object) represented by a data point cluster, of the ultrasonic echo signal represented by the ultrasonic echo signal data. These characteristic data enable, for example a description and examination of backscattering patterns.

Further examples of characteristic data are amplitude, frequency and/or phase information.

The characteristic data are, for example, determined at least partly as a function of the values of the signal strength represented by one or a plurality of data points (e.g. a plurality of data points of a data point cluster) and/or the detection times represented by one or a plurality of data points. For example, the characteristic data comprise a value and/or an average value (e.g. a middle value) of the amplitude, the frequency and/or the phase of the signal portion of the ultrasonic echo signal represented by one or a plurality of data points (e.g. a plurality of data points of a data point cluster).

One or a plurality of the reflection objects are then classified at least partly based on the characteristic data obtained as the result of the determination. For example, the characteristic data are selected such that they enable a distinction to be made between different types of reflection objects and a corresponding classification of the reflection objects. For example, based on the characteristic data, different types of reflection objects, for example, different traffic objects, such as pedestrians, cyclists and motor vehicles can be distinguished from each other. For example, based on phase and/or frequency information, the speed of the reflection objects can be estimated and/or determined such that reflection objects with different speeds can be distinguished and correspondingly classified. For example, reflection objects moving at least quickly and slowly can be distinguished based on phase and/or frequency information. This distinction is considered, for example during classification. A quickly moving reflection object can, for example, mean a classification as a motor vehicle, whereas a slowly moving reflection object could, for example, mean a classification as a pedestrian or cyclist. In addition to the speed, further properties of the reflection objects can be determined and/or estimated based on the characteristic data such as for example the dimensions and/or the position and taken into account for the classification.

The classification can, for example, be performed locally by the apparatus according to the invention. However, it is also possible for the classification to be performed by one or a plurality of apparatuses according to the invention for a local group of apparatuses according to the invention (e.g. a group of apparatuses according to the invention of the system according to the invention). The classification can, for example, also be performed by a server (e.g. a server of the system according to the invention). The classification can of course also be performed in a distributed manner by different apparatuses and/or servers.

The present invention thus enables an evaluation of the ultrasonic echo signal with regard to signal portions, which trace back at least substantially to reflections on different reflection objects in the detection range of the ultrasonic sensor, and is not limited to the evaluation of the initial reflection. In this case, by grouping and determining the characteristic data for the respective data point clusters, different classes of reflection objects can be detected and distinguished in the detection range of the ultrasonic sensor such as different (e.g. moving) traffic objects. The detection range of an ultrasonic sensor can thus be increased, for example an ultrasonic sensor can be used for traffic monitoring for a plurality of lanes or for monitoring a plurality of parking spaces. If the evaluation of the ultrasonic echo signal is limited to the initial reflection, only one lane or one parking space can, in contrast, be reasonably monitored by an ultrasonic sensor.

Additional advantages of the disclosed invention are described below based on exemplary embodiments of the method according to the invention, of the computer program according to the invention, of the apparatus according to the invention and of the system according to the invention, whose disclosure should apply in equal measure to the respective categories (method, computer program, apparatus, system).

According to an exemplary embodiment of the invention, each data point of the ultrasonic echo signal data represents the value of the signal strength of the detected ultrasonic echo signal at a detection time. As described above, a data point of the ultrasonic echo signal data comprises, for example, a representation (e.g. a digital representation) of the value of the signal strength of the ultrasonic echo signal detected by the ultrasonic sensor at a determined detection time. Such a representation of a value of the signal strength is, for example, a digital value, which at least substantially corresponds to the value of the signal strength (e.g. to a round value or to a digitalised value of the signal strength). Such a data point can, for example, also comprise a representation (e.g. a digital representation) of the detection time. A representation of the detection time is, for example a digital value, which corresponds at least substantially to the date and time of the detection time (e.g. to the Unix time and/or the POSIX time of the detection time).

According to an exemplary embodiment of the invention, the ultrasonic sensor is stationary. In this case, stationary should, for example be understood as the ultrasonic sensor being permanently located at a determined position (e.g. a geographic and/or spatial position). For example, the ultrasonic sensor is permanently installed and/or mounted at this position. For example, the ultrasonic sensor is installed and/or mounted in a sidefire configuration (e.g. in an inclined and/or angled alignment, e.g. in an inclined and/or angled alignment to the detection range and/or to a base surface, e.g. to the earth's surface in the detection range). This has the effect of the detection range of the ultrasonic sensor covering a larger region than for example with a perpendicular alignment to the detection region and/or to a base surface. Exemplary embodiments are also possible in which the ultrasonic sensor is pivotable. For example, the ultrasonic sensor is mechanically pivotable and/or the detection direction of the ultrasonic sensor is electrically pivotable (e.g. by a phased array receiver arrangement). The ultrasonic sensor is, for example, not part of a transportable apparatus (e.g. of a vehicle) in any of these exemplary embodiments.

The ultrasonic sensor may, for example, be part of a plurality of ultrasonic sensors, for example part of an ultrasonic sensor array. For example, the system according to the invention comprises such a plurality of ultrasonic sensors.

For example, a plurality of ultrasonic sensors can be arranged such that they asynchronously detect an ultrasonic echo signal, for example by a sequence of ultrasonic sensors detecting the ultrasonic echo signal in time periods following each other chronologically. The results from ultrasonic sensor to ultrasonic sensor may, for example, be thereby further optimised.

According to one exemplary embodiment of the invention, the method according to the invention also comprises emitting and/or prompting the emitting of one or a plurality of ultrasonic pulses.

For example, the emitted ultrasonic pulses are based on a time-limited prototype pulse, which is modulated and/or frequency-shifted to an ultrasonic carrier frequency (e.g. 44 kHz).

For example, the ultrasonic pulses are emitted at regular time intervals such that the time difference between the emission times of two consecutive ultrasonic pulses is always the same. In this case, an emission time of an ultrasonic pulse should, for example, be understood as the period at which the emission of the ultrasonic pulse starts. The ultrasonic pulses are, for example, also equal and/or the ultrasonic pulses have, for example, the same pulse length. However, the ultrasonic pulses can also be unequal and/or be emitted at irregular time intervals and/or with different pulse lengths. Embodiments are also possible in which the time intervals are changeable between two consecutive ultrasonic pulses and/or the pulse length of the ultrasonic pulses.

For example, the ultrasonic pulses are emitted by the ultrasonic sensor. In this case, the ultrasonic sensor is, for example, formed as a combined ultrasonic emitter and ultrasonic detector.

Embodiments are also possible in which the ultrasonic pulses are emitted from a correspondingly configured ultrasonic emitter separate to the ultrasonic sensor. For example, the ultrasonic emitter is stationary. In this case, stationary should, for example be understood, as described above concerning the ultrasonic sensor, as the ultrasonic emitter being permanently located at a determined position. For example, the ultrasonic emitter is permanently installed and/or mounted at this position. For example, the ultrasonic emitter is installed and/or mounted in a sidefire configuration (e.g. in an inclined and/or angled alignment, e.g. in an inclined and/or angled alignment to the ground surface, e.g. to the earth's surface). Embodiments are also possible in which the ultrasonic emitter is pivotable. For example, the ultrasonic emitter is mechanically pivotable and/or the emission direction of the ultrasonic emitter is electronically pivotable (e.g. by a phased array emitter arrangement). The ultrasonic emitter is, for example, not part of a transportable apparatus (e.g. of a vehicle) in any of these embodiments.

For example, the apparatus according to the invention comprises the ultrasonic emitter.

Alternatively or additionally, the apparatus according to the invention can, for example, actuate the ultrasonic emitter in order to prompt the emitting of the ultrasonic pulses by the ultrasonic emitter. For example, the apparatus according to the invention comprises communication means which are configured to communicate a corresponding actuation signal to the ultrasonic emitter. An example of such communication means, as explained above, is a communication interface, for example a wireless communication interface or a wired communication interface. In this case, the ultrasonic emitter is, for example, not part of the apparatus according to the invention.

An ultrasonic emitter comprises, for example a piezoelectric transducer which, for example converts an electric signal into an ultrasonic pulse.

The ultrasonic emitter (and/or the ultrasonic sensor formed as a combined ultrasonic sensor and ultrasonic detector) can, for example be part of a plurality of ultrasonic emitters (and/or ultrasonic sensors), for example part of an ultrasonic emitter array (and/or ultrasonic sensor array). For example, the system according to the invention comprises such a plurality of ultrasonic emitters (and/or ultrasonic sensors).

Every ultrasonic pulse emitted from another ultrasonic emitter of a plurality of ultrasonic emitters and/or another ultrasonic sensor of a plurality of ultrasonic sensors has, for example a different ultrasonic carrier frequency. This has the effect of signal portions in an ultrasonic echo signal tracing back to reflections from ultrasonic pulses of different ultrasonic emitters and/or ultrasonic sensors, for example, being able to at least substantially be separated by band-pass filtering.

Accordingly, the method according to the invention can, for example, comprise such band-pass filtering of the ultrasonic echo signal detected by the ultrasonic sensor. Alternatively or additionally, the ultrasonic echo signal data obtained can, for example, represent a correspondingly band-filtered ultrasonic echo signal which comprises signal portions tracing back at least substantially to reflections of ultrasonic pulses of a single ultrasonic emitter.

According to an exemplary embodiment of the invention, the reflections at least substantially comprise reflections of the emitted ultrasonic pulses on reflection objects. For example, the ultrasonic echo signal comprises signal portions, which trace back at least substantially to reflections of one or a plurality of the previously emitted ultrasonic pulses on reflection objects.

According to one exemplary embodiment of the invention, the method according to the invention also comprises dividing the ultrasonic echo signal data into a plurality of ultrasonic echo signal data blocks, wherein the ultrasonic echo signal data blocks represents consecutive time periods of equal time period length of a time curve of a value of the signal strength of the detected ultrasonic echo signal.

For example, each of the time periods starts with the emission time of an ultrasonic pulse. The time period length of each of the time periods also, for example, corresponds to the time difference between the emission times of two consecutive ultrasonic pulses. This has, for example, the effect of the time curve of the signal strength of the detected ultrasonic echo signal represented by an ultrasonic echo signal data block being determined at least substantially by reflections of the ultrasonic pulse emitted at the start of the respective time period and is thus also denoted below, by way of example, as an ultrasonic pulse response.

This also, for example allows data points, which are located at the same position in different ultrasonic echo signal data blocks to be associated with the same signal runtime (based on the emission time at the start of the respective time period) when the time difference between the emission times of two consecutive ultrasonic pulses is always the same. A detection time should, for example be understood as being associated with a signal runtime when the time difference between the detection time and an emission time of a previously emitted ultrasonic pulse corresponds to the signal runtime. In this case, the signal runtime should, for example be understood as the time difference between the emission time of an ultrasonic pulse and a detection time of the signal portions tracing back to one or a plurality of reflections of the ultrasonic pulse in an ultrasonic echo signal.

This embodiment is, for example, advantageous when the ultrasonic pulses are emitted from a stationary ultrasonic emitter and/or stationary ultrasonic sensor and the ultrasonic echo signal is detected by a stationary ultrasonic sensor since, in such a case, signal portions of the detected ultrasonic echo signal tracing back to reflections of a plurality of ultrasonic pulses on a reflection object at a determined distance cover the same distance and thus have the same signal runtime. In other words, the data points, which are located at the same position in different ultrasonic echo signal data blocks, in this case represent a signal portion of the ultrasonic echo signal, which traces back at least substantially to a reflection of the respective ultrasonic pulse on a reflection object at the same distance (e.g. at the same distance from the ultrasonic sensor and/or ultrasonic emitter).

According to one exemplary embodiment of the invention, the method according to the invention also comprises determining a graphic representation of the ultrasonic echo signal data at least partly as a function of the ultrasonic echo signal data blocks.

As a result of determining the graphic representation, an ultrasonic echo signal data structure that can be graphically represented is, for example, obtained, like a two-dimensional data field and/or a data array and/or a graphic file (e.g. a graphic file in an image data format such as the bitmap format, BMP format).

The graphic representation is, for example a two-dimensional representation of the ultrasonic echo signal data. Alternatively or additionally, the graphic representation is, for example, a graphic interpretation and/or abstraction of the ultrasonic echo signal data.

For example, the graphic representation is and/or comprises a pixel arrangement with pixels arranged in a grid (e.g. the ultrasonic echo signal data structure obtained as a result of determining the graphic representation can be represented as a pixel arrangement). For example, each pixel of the pixel arrangement is determined as a function of a data point of the ultrasonic echo signal data. For example, the colour, shading and/or grey scale of a pixel is determined as a function of the value of the signal strength represented by the respective data point.

For example, adjacent pixels in a grid column of the grid, are, for example, determined by consecutive data points of a respective ultrasonic echo signal data block of the ultrasonic echo signal data blocks; and adjacent pixels in a grid row of the grid are, for example, determined by data points, which are located in consecutive ultrasonic echo signal data blocks (e.g. located at the same position in consecutive ultrasonic echo signal data blocks). This has, for example the effect of the pixels of a grid column being determined at least substantially by a respective ultrasonic pulse response (i.e. at least substantially by reflections of the ultrasonic pulse emitted at the start of the respective time period) when each of the time periods represented by the ultrasonic echo signal data blocks starts with the emission time of an ultrasonic pulse and the time period length of each of the time periods corresponds, for example to the time difference between the emission times of two consecutive ultrasonic pulses. In this case, the pixels, which are located at the same position in different grid columns, represent, for example a signal portion of the ultrasonic echo signal represented by the ultrasonic echo signal data, which traces back at least substantially to a reflection of the respective ultrasonic pulse on a reflection object at the same distance (e.g. at the same distance from the ultrasonic sensor and/or ultrasonic emitter).

The signal portion of the ultrasonic echo signal, represented by the ultrasonic echo signal data, tracing back to reflections of a plurality of consecutive ultrasonic pulses on an unmoving reflection object is represented in such a pixel arrangement, for example by pixels, which are located in consecutive grid columns at the same position. In contrast, the signal portion of the ultrasonic echo signal, represented by the ultrasonic echo signal data, tracing back to reflections of a plurality of consecutive ultrasonic pulses on a moving reflection object is represented in such a pixel arrangement, for example by pixels, which are located in consecutive grid columns at different positions.

This is, for example, advantageous in order to be able to detect and analyse, for example with image processing algorithms, signal portions tracing back to reflections in the ultrasonic echo signal represented by the ultrasonic echo signal data. A human observer is also capable by means of such a pixel arrangement of being able to detect and/or analyse signal portions, tracing back to reflections, of the ultrasonic echo signal represented by the ultrasonic echo signal data.

For example, the method according to the invention comprises applying an image processing algorithm such as a two-dimensional filter (e.g. a two-dimensional hamming filter) to the graphic representation and/or an ultrasonic echo signal data structure which can be graphically represented and obtained as a result of determining the graphic representation.

For example, grouping of a plurality of data points of the ultrasonic echo signal data into one or a plurality of data point clusters is at least partly based on the graphic representation (e.g. the above-described pixel arrangement) and/or an ultrasonic echo signal data structure which can be graphically represented and obtained as a result of determining the graphic representation. Grouping of a plurality of data points of the ultrasonic echo signal data into one or a plurality of data point clusters comprises, for example, applying a clustering algorithm to the graphic representation (e.g. the above-described pixel arrangement) and/or an ultrasonic echo signal data structure which can be graphically represented and obtained as a result of determining the graphic representation.

The clustering algorithm can, for example, be a hierarchical, a density-based or a partitioned clustering algorithm as well as a combination of different clustering algorithms. An example of a density-based clustering algorithm is the DBSCAN (Density-Based Spatial Clustering of Applications with Noise) algorithm.

According to one exemplary embodiment of the invention, grouping a plurality of data points of the ultrasonic echo signal data into one or a plurality of data point clusters comprises applying a clustering algorithm to the ultrasonic echo signal data and/or data points of the ultrasonic echo signal data. This can, for example, be carried out by applying, as described above, a clustering algorithm to the graphic representation (e.g. the above-described pixel arrangement) and/or an ultrasonic echo signal data structure which can be graphically represented and obtained as a result of determining the graphic representation.

According to one exemplary embodiment of the method according to the invention, the characteristic data comprise at least one or a plurality of the following information:
amplitude, frequency and/or phase information,
information concerning localisation, distribution, form, morphology, pattern and/or expansion of a data point cluster (e.g. a data point cluster of the data point clusters),
information concerning reflection energy of the signal portion, represented by the data points of a data point cluster (e.g. a data point cluster of the data point clusters), of the ultrasonic echo signal represented by the ultrasonic echo signal data,
information concerning a signal runtime of the signal portion, represented by the data points of a data point cluster (e.g. a data point cluster of the data point clusters), of the ultrasonic echo signal represented by the ultrasonic echo signal data.

The characteristic data are, for example, determined at least partly as a function of the ultrasonic echo signal data (e.g. at least partly as a function of one or a plurality of data points of the ultrasonic echo signal data).

As described above, the characteristic data, for example, comprise amplitude, frequency and/or phase information.

Amplitude information can, for example, be obtained by determining an average value of the amplitude (e.g. an average value of the signal strength) of the signal portion of the ultrasonic echo signal represented by one or a plurality of data points of a data point cluster (e.g. a data point cluster of the data point clusters). An average value is, for example, supposed to be understood as the median, the arithmetic average and/or the geometric average. For example, the characteristic data comprise one or a plurality of such average values of the amplitude information. Such amplitude information allows, for example, conclusions to be drawn concerning the signal portion, reflected by a reflection object, of a previously-emitted ultrasonic pulse. This is, for example, advantageous in order to be able to distinguish different types of reflection objects from one another and classify them correspondingly.

Frequency information can, for example, be obtained by determining a frequency spectrum of the signal portion of the ultrasonic echo signal represented by one or a plurality of data points of a data point cluster and/or a frequency difference between the frequency of the signal portion of the ultrasonic echo signal represented by one or a plurality of data points of a data point cluster (e.g. a data point cluster of the data point clusters) and the frequency of a previously-emitted ultrasonic pulse. For example, the characteristic data comprise a representation of the frequency spectrum and/or the value of the frequency difference as frequency information. An analysis of the frequency spectrum can, for example, produce indications of a frequency shift due to the Doppler effect in the case of a reflection on a moving reflection object. The presence of a frequency difference can, for example directly indicate a frequency shift due to the Doppler effect in the case of a reflection on a moving reflection object. The frequency shift, in this case, depends on the movement speed and the movement direction of the reflection object. Frequency information is thus, for example, advantageous in order to be able to distinguish reflection objects moving at different speeds from one another and to classify them correspondingly.

Phase information can, for example, be obtained by determining a phase change between the phase of the signal portion of the ultrasonic echo signal represented by one or a plurality of data points of a data point cluster (e.g. a data point cluster of the data point clusters) and the phase of the signal portion of the ultrasonic echo signal represented by one or a plurality of different data points of the data point cluster. For example, such a phase change can be determined by comparing the phases of the signal portions of the ultrasonic echo signal represented by a plurality of data points of a data point cluster of consecutive ultrasonic echo signal data blocks. A phase change can, for example, trace back to a reflection on a moving reflection object. In this case, the phase change depends on the movement speed and the movement direction of the reflection object. Phase information is thus, for example, advantageous in order to be able to distinguish reflection objects moving at different speeds from one another and to classify them correspondingly.

Alternatively or additionally, the characteristic data can comprise information concerning the reflection energy and/or signal runtime of the signal portion, represented by a data point cluster (e.g. a data point cluster of the data point clusters) (e.g. tracing back at least substantially to reflections on a reflection object), of the ultrasonic echo signal represented by the ultrasonic echo signal data.

Information concerning the reflection energy can, for example be obtained by determining the value of the energy of the signal portion, represented by a data point cluster (e.g. tracing back at least substantially to reflections on a reflection object), of the ultrasonic echo signal represented by the ultrasonic echo signal data. For example, the characteristic data comprise one or a plurality of such energy values as information concerning the reflection energy. These characteristic data, if necessary, allow conclusions to be drawn concerning the reflection surface and/or the reflection angle.

Information concerning the signal runtime can, for example, be obtained by determining the signal runtime of the signal portion, represented by one or a plurality of data points of a data point cluster (e.g. tracing back at least substantially to reflections on a reflection object), of the ultrasonic echo signal represented by the ultrasonic echo signal data. The minimum and maximum signal runtime of the signal portion, represented by a data point cluster (e.g. tracing back at least substantially to reflections on a reflection object), of the ultrasonic echo signal represented by the ultrasonic echo signal data can, for example, be determined. For example, the characteristic data comprise one or a plurality of values of such signal runtime as information concerning the signal runtime. These characteristic data are, for example, an indication of the position of the reflection object such as the distance between the reflection object and the ultrasonic sensor and/or ultrasonic emitter. These characteristic data also allow, for example, conclusions to be drawn concerning outer dimensions of the reflection object (e.g. height and/or width of the reflection object). For example, outer dimensions of the reflection object can at least partly be determined and/or estimated as a function of these characteristic data (e.g. by a comparison with corresponding characteristic data, if a reflection on a reflection object or a reflection on another reflection object does not take place). For example, outer dimensions of different reflection objects can be compared. This is, for example, advantageous in order to be able to distinguish reflection objects with different outer dimensions and to classify them.

Alternatively or additionally, the characteristic data can, for example, describe characteristic properties of the data point clusters. This includes, for example, information concerning localisation, distribution, form, morphology, pattern and expansion of a data point cluster. These characteristic data enable, for example a description and examination of backscattering patterns.

Information concerning localisation, distribution, form, morphology, pattern and expansion of a data point cluster should, for example, be understood as the geometric form of a reflection pattern and/or the energy distribution into different dimensions and/or the typical reflection paths of a determined object and/or object type. This is, for example, advantageous in order to be able to detect reflection patterns that are typical for determined types of reflection objects.

According to one exemplary embodiment of the method according to the invention, classifying one or a plurality of the reflection objects comprises one or a plurality of the following steps:
detecting one or a plurality of the reflection objects,
assigning one or a plurality of reflection objects to an object class,
determining a probability for the affiliation of one or a plurality of reflection objects to an object class.

Detecting one or a plurality of the reflection objects should, for example, be understood as detecting the presence of one or a plurality of reflection objects in the detection range of the ultrasonic sensor. This can, for example, be carried out based on the data point clusters. For example, it is assumed that the data points of a data point cluster at least substantially represent signal portions of the ultrasonic signal tracing back to reflections of the ultrasonic pulse on a reflection object. Accordingly, one or a plurality of reflection objects are, for example, detected when the data points are grouped into one or a plurality of data point clusters.

An object class comprises, for example, reflection objects of a determined type, for example traffic objects of a determined type such as pedestrians, cyclists, motor vehicles (e.g. motorbikes, passenger cars, trucks), etc.

Based on the characteristic data, the reflection objects (e.g. the detected reflection objects) are, for example, assigned to an object class (i.e. classified as the object of this object class).

As described in detail below, such an assignment of the reflection objects to an object class can, for example, be carried out by an algorithm for machine learning and/or a machine learning technique.

The assignment of the reflection objects to an object class can also be carried out based on a predefined decision tree. It can thus be decided in a first stage of a decision tree for assigning the reflection objects to a traffic object class whether the respective reflection object is a pedestrian, a cyclist or a motor vehicle and assign it correspondingly. This assignment can, for example, be made at least partly as a function of an estimated and/or determined speed of the respective reflection object. In a simple example, reflection objects with an estimated speed of less than 10 km/h can be assigned to the traffic object class of pedestrian, reflection objects with an estimated speed of between 10 and 25 km/h can be assigned to the traffic object class of cyclist and reflection objects with an estimated speed of greater than 25 km/h can be assigned to the traffic object class of motor vehicles. In addition to the speed, further properties of the reflection objects can be determined and/or estimated based on the characteristic data such as for example the outer dimensions and/or the position (such as the distance between the reflection object and the ultrasonic sensor and/or ultrasonic emitter) and taken into account for the assignment. If it has been decided that the respective reflection object is a motor vehicle, it can then be decided in an optional additional stage of the decision tree whether it is a truck or a passenger vehicle or a motorbike/scooter. The assignment can be even further refined in optional additional stages of the decision tree.

Alternatively or additionally, a probability for the affiliation of the reflection objects to an object class is determined based on the characteristic data. The reflection objects are then, for example, assigned to the object class with the highest probability. The determination of the probability is, for example, advantageous for allowing more precise extrapolations, for example with statistic evaluations (e.g. a traffic statistic and/or an averaging over time).

According to one exemplary embodiment of the method according to the invention, the method also comprises estimating and/or determining (e.g. approximately determining) location and/or movement information of one or a plurality of reflection objects.

As described above, the signal runtime of a signal portion of the ultrasonic echo signal represented by the ultrasonic echo signal data depends on the distance at which a reflection object is located from the ultrasonic emitter and/or the ultrasonic sensor. Accordingly, location information (e.g. the distance) of a reflection object can, for example, be estimated and/or determined based on the signal runtime of a signal portion, at least substantially reflected by the reflection object, of the ultrasonic echo signal represented by the ultrasonic echo signal data.

Movement information can, for example, be estimated and/or determined based on frequency and/or phase information of a signal portion, at least substantially reflected by the reflection object, of the ultrasonic echo signal represented by the ultrasonic echo signal data. As described above, an analysis of the frequency spectrum of the signal portion can, for example, produce indications of a frequency shift due to the Doppler effect in the case of a reflection on a moving reflection object. The presence of a frequency difference can, for example also directly indicate a frequency shift due to the Doppler effect in the case of a reflection on a moving reflection object. The frequency shift, in this case, depends on the speed and the movement direction of the reflection object such that the speed and the movement direction can be estimated and/or determined based on this information. For example, the movement information comprises a value of the speed and/or a representation of the direction of the reflection object.

According to one exemplary embodiment of the invention, classifying the ultrasonic echo signal data is carried out at least partly as a function of an algorithm for machine learning and/or a machine learning technique.

For example, assignment of the reflection objects to an object class can be carried out by an algorithm for machine learning and/or a machine learning technique.

Machine learning can, for example, be carried out in the form of supervised machine learning or in the form of unsupervised machine learning. With supervised machine learning, the result of the classification is, for example, compared with reference results and/or data and the algorithm correspondingly adapted. The reference results and/or data can, for example, originate from another sensor (e.g. an imaging sensor such as a camera) or from another apparatus or be obtained by laboratory tests. The comparison with reference results and/or data can, for example, be performed during an initial training phase or continuously. Machine learning can also take into account prior information such as e.g. the statistical environment of the detection range of the ultrasonic sensor (e.g. number and course of lanes as well as unmoving objects such as houses in the detection range).

Machine learning techniques includes, for example an artificial neuronal network, a support vector machine, a linear discrimination analysis or a combination of these techniques.

According to one exemplary embodiment of the method according to the invention, the method also comprises providing the result of the classification for one or a plurality of applications. Such an application can, for example, be implemented by a computer program executed on a processor.

Providing the results of the classification should, for example, be understood as the result being communicated to the application and/or a apparatus which executes the application. These apparatuses may, for example, be a server, for example a cloud and/or backend server and/or one or a plurality of additional apparatuses according to the invention and/or a control apparatus (e.g. a control apparatus for controlling a light means such as an ICE Gateway operated by the company, ICE Gateway GmbH). For example, the apparatus according to the invention comprises communication means which are configured to communicate the result of the classification. An example of such communication means, as described above, is a communication interface, for example a wireless communication interface or a wired communication interface.

The application takes into account, for example, the results of the classification by a plurality of apparatuses according to the invention. For example, the apparatus, which executes the application, obtains (e.g. receives) the results of the classification from a plurality of apparatuses according to the invention.

One possible application for classifying moving reflection objects is, for example, traffic counting and/or monitoring. The respective object class (e.g. traffic object class) or a probability distribution of object classes of the detected reflection object obtained as a result of the classification can, for example, be provided for such traffic counting and/or monitoring. For example, traffic and/or vehicle density of the lanes located in the detection range of the ultrasonic sensor can be determined based on this. Location information can also, for example, be provided in order to enable, for example, precise determination of the traffic and/or vehicle density for a lane. Additional information concerning individual reflection objects, such as e.g. location and movement information can also be present to complement this data. By optionally taking into account the results of the classification by a plurality of apparatuses according to the invention, large-scale traffic counting and/or monitoring can, for example, be achieved, in which the results of the classification flow to the respective sites of the plurality of apparatuses according to the invention.

An additional possible application for the classification of reflection objects is, for example, parking space monitoring. The respective object class (e.g. vehicle type) obtained as a result of the classification as well as location information of the detected reflection objects are, for example, provided for such parking space monitoring. The status (e.g. occupied or free) of a parking space located in the detection range of the ultrasonic sensor can, for example, be determined at least partly based on the provided results and, for example, additional information concerning the parking space (e.g. location information, size information, etc.) and/or previously provided results. For example, it is determined that the parking space is occupied if an object of a predefined object class is detected at the location of the parking space for a predefined time period. The results of the classification by a plurality of apparatuses according to the invention can also optionally be taken into account for this purpose. In one possible application, the detected objects or the status (e.g. occupied or free) of one or a plurality of parking spaces can be further processed by the apparatus according to the invention and/or communicated to other apparatuses (e.g. communicated by communication means of the apparatus according to the invention to another apparatus). The communication connection is, for example, a direct connection (e.g. a peer-to-peer connection via wireless local radio network technology such as WLAN) or an indirect connection (e.g. a connection via the internet). The other apparatus is, for example, a mobile user apparatus (e.g. a mobile phone such as a smartphone). A user can, for example, reserve a free parking space by means of their user apparatus (e.g. with the aid of a computer program such as an app running on said apparatus) via such a communication connection and/or pay a parking fee and/or report a wrongly occupied parking space.

An additional possible application is, for example a controller. For example, if the provided result of the classification corresponds to a predefined result, a control signal (e.g. a predefined control signal) can be emitted by the controller. It is understood that the control signal may depend at least partly on different results and/or events (e.g. on signals detected by different sensors and/or different sensor types). Such a control signal can, for example, serve to actuate an actuator (e.g. a light means and/or a camera). For example, the actuator can be activated by the control signal if a moving object is detected. For example, the actuator is part of the apparatus according to the invention. However, embodiments are also possible in which the actuator is separate from the apparatus according to the invention. For example, the apparatus according to the invention comprises communication means which are configured to communicate the control signal to the actuator. An example of such communication means, as described above, is a communication interface, for example a wireless communication interface or a wired communication interface. Such an actuator is, for example, a light means and/or a control apparatus for controlling a light means.

Additional applications such as traffic logic, forecasting, decision level, visualisation for users (e.g. customers and/or users) are also conceivable. One application for visualisation for users offers, for example, a possibility to display the recorded data for a user such as for example a website.

The results of the classification can also be used as feedback, for example in order to influence the grouping of a plurality of data points of the ultrasonic echo signal data, determining characteristic data and/or standardising the ultrasonic echo signal data.

According to one exemplary embodiment of the method according to the invention, the method also comprises re-grouping a plurality of data points of a data point cluster into one or a plurality of new and/or existing data point clusters. This allows, for example, a correction of incorrectly grouped and/or separated data point clusters.

According to one exemplary embodiment of the method according to the invention, the method also comprises:
fusing the ultrasonic echo signal data with additional ultrasonic echo signal data, and/or
fusing the characteristic data with additional characteristic data, wherein the additional characteristic data have been determined at least partly as a function of additional ultrasonic echo signal data.

For example, the additional ultrasonic echo signal data can represent an ultrasonic echo signal detected by another ultrasonic sensor. Alternatively or additionally, the additional ultrasonic echo signal data can, for example, represent the time curve of the signal strength of an additional ultrasonic echo signal which comprises signal portions tracing back at least substantially to reflections of ultrasonic pulses of a different ultrasonic emitter and/or ultrasonic sensor.

Fusing the ultrasonic echo signal data with additional ultrasonic echo signal data should, for example, be understood as the ultrasonic echo signal data being compared, combined and/or augmented with the additional ultrasonic echo signal data. Accordingly, fusing the characteristic data with additional characteristic data should be understood as the characteristic data being compared, combined and/or augmented with the additional characteristic data.

The fused ultrasonic echo signal data can, for example, be evaluated with regard to different characteristic data such as amplitude, signal runtime, phase and frequency differences or additional characteristics such as for example reflection patterns.

Essentially, fusing can take place both prior to classification and also after classification.

Fusing is, for example, advantageous when it takes place prior to classification in order to increase the data basis for the classification and thus to be able to improve the result of the classification, for example by using location information and/or triangulation techniques and/or additional fusing techniques at signal level. One possibility of this is beamforming which allows the determination of location information of one or a plurality of reflection objects based on fused ultrasonic echo signal data (e.g. a plurality of ultrasonic sensors).

According to one exemplary embodiment of the method according to the invention, the method also comprises standardising the ultrasonic echo signal data.

For example, standardising the ultrasonic echo signal data comprises standardising at least one first data point of the ultrasonic echo signal data at least partly as a function of at least one second data point of the ultrasonic echo signal data, wherein the first data point represents the value of the signal strength of the detected ultrasonic echo signal at a first detection time, wherein the second data point of the ultrasonic echo signal data represents the value of the signal strength of the detected ultrasonic echo signal at an earlier second detection time, wherein standardised ultrasonic echo signal data comprising the standardised first data point is obtained as a result of standardising the ultrasonic echo signal data. The first data point and the second data point are, for example, associated with the same signal runtime and/or located, for example, at the same position in consecutive ultrasonic echo signal data blocks.

Standardising the ultrasonic echo signal data should, for example, be understood according to a first aspect as signal portions tracing back to reflections of one or a plurality of previously emitted ultrasonic pulses on unmoving and/or virtually unmoving reflection objects being at least partly reduced in the standardised ultrasonic echo signal represented by the standardised ultrasonic echo signal data according to the first aspect with respect to the detected ultrasonic echo signal. This first aspect is, for example, advantageous when moving reflection objects (e.g. traffic objects in the context of traffic monitoring) are supposed to be classified in order to, in this case, reduce disrupting signal portions tracing back to reflections on unmoving and/or virtually unmoving reflection objects. According to a second aspect, standardising the ultrasonic echo signal data should, for example, in the present case be understood as signal portions tracing back to reflections of one or a plurality of previously emitted ultrasonic pulses on moving objects being at least partly reduced in the standardised ultrasonic echo signal represented by the standardised ultrasonic echo signal data according to the second aspect with respect to the detected ultrasonic echo signal. This second aspect is, for example, advantageous when unmoving reflection objects (e.g. in the context of parking space monitoring) are supposed to be classified. By combining the first and second aspect, the signal portions tracing back to reflections on unmoving and/or virtually unmoving objects and reflections on moving objects are separated from each other.

Standardising at least the first data point of the ultrasonic echo signal data according to the first and the second aspect takes place, for example, by determining a standardised first data point based on at least the first data point and the second data point. For example, a representation of a value of a signal strength encompassed by the standardised first data point is determined based on the values of the signal strength of the detected ultrasonic echo signal represented by the first data point and the second data point. As a result of standardising the ultrasonic echo signal data, standardised echo signal data are, for example, obtained which comprise at least the standardised first data point.

For example, standardising the at least first data point comprises at least one of:
Determining a signal strength average value at least as a function of the values of the signal strength of the ultrasonic echo signal represented by the first data point and the second data point;
determining a signal strength standard deviation and/or a signal strength variance at least partly as a function of the values of the signal strength of the ultrasonic echo signal represented by the first data point and the second data point;
dividing the signal strength average value by the signal strength standard deviation;
subtracting the signal strength average value from the value of the signal strength of the detected ultrasonic echo signal represented by the first data point; and
dividing the result of the subtraction of the signal strength average value from the value of the signal strength of the detected ultrasonic echo signal represented by the first data point by the signal strength standard deviation.

According to one exemplary embodiment of the method according to the invention, the method also comprises applying an analysis and compensation algorithm to the ultrasonic echo signal data such as for example an algorithm for multiple reflection analysis/compensation and/or for dispersion analysis/compensation. This is, for example, advantageous in order to compensate different signal runtimes of the signal portions tracing back to reflections on a reflection object due to multiple reflections. This can, for example, occur through prior knowledge of reflection patterns of different objects and/or learned information concerning reflection patterns which allow compensation and/or further analysis.

According to one exemplary embodiment of the invention, the apparatus according to the invention is a control apparatus for controlling a light means, comprises a control apparatus for controlling a light means and/or is part of a control apparatus for controlling a light means. For example, the apparatus according to the invention comprises means which are configured to control one or a plurality of light means. Control can, for example, be carried out at least partly as a function of the result of the classification of the ultrasonic echo signal data. An example of such a control apparatus is, for example, a control apparatus for a traffic light and/or one or a plurality of streetlamps.

Such a control apparatus for controlling a light means of a lamp outdoors is, for example described in the patent application with the file reference DE 10 2014 102 678.0 to which explicit reference is made here. Such a apparatus is, for example, also a apparatus manufactured by the company, ICE Gateway under the product name ICE Gateway.

Controlling a light means (e.g. a light means connected to the apparatus) should, for example, be understood as switching on, switching off and/or dimming the light means.

For example, the apparatus according to the invention also comprises one or a plurality of energy supply means. For example, the energy supply means are configured to be connected to the light means and to supply the light means with energy and/or to provide current to operate the light means. For example, the light means are controlled by the energy supply means being controlled. For example, the energy supply means comprise a converter, a controllable driver circuit and/or a controllable voltage transformer (e.g. a controllable direct voltage transformer).

The light means is preferably a direct current-based light means. For example, the light means is an LED light means (Light Emitting Diode) and/or an OLED light means (Organic Light Emitting Diode). The light means can, however, also be an alternating current-based light means. For example, the light means is a bulb and/or a gas discharge lamp.

For example, the light means are controlled at least partly as a function of the result of the evaluation of the ultrasonic echo signal data. The light means are, for example, switched on or dimmed up in the case of determined results of the classification and switched off or dimmed down in the case of other results of the classification.

As a result, a apparatus for controlling a light means is, for example, provided with additional functions such as processing ultrasonic echo signal data. This is, for example, advantageous since no additional installation effort has to be spent, for example, for the provision of additional functions and the means of the apparatus already present can be used for controlling the light means. Such apparatuses for controlling a light means are typically also part of a lighting system (e.g. a light system of a city) which comprises a plurality of apparatuses for controlling a light means such that a larger public area can be covered.

For example, the apparatus according to the invention can be arranged or is arranged on or in a lamp outdoors, in particular a streetlamp. For example, the apparatus according to the invention is part of a lighting apparatus such as a lamp, for example a lamp outdoors, in particular a streetlamp and/or a lamp of a traffic light.

Arranged on or in a lamp outdoors should, for example, be understood as the apparatus according to the invention being arranged inside the lamp (e.g. in the lamp head or in the mast) and/or on the housing of the lamp (e.g. on the lamp head and/or on the mast). For example, the apparatus according to the invention is arranged in the light, on or at the light, in the lamp and/or at the lamp.

According to one exemplary embodiment of the invention, the apparatus according to the invention is arranged and/or applied on or in a bus stop, at or on a train platform, at or on a public square, at a traffic light crossing, at or in a public building (e.g. at an entrance and/or exit door) in order to measure the inflow of objects (such as e.g. vehicles, passers-by and/or visitors).

According to one exemplary embodiment of the invention, the system according to the invention also comprises one or a plurality of control apparatuses for controlling a light means. It is understood that the system according to the invention can, alternatively or additionally, comprise additional external components (e.g. sensors, servers and/or apparatuses).

According to one exemplary embodiment of the invention, the system according to the invention is a lighting system (e.g. of a city).

According to one exemplary embodiment of the invention, the system according to the invention also comprises one or a plurality of additional apparatuses according to the invention and/or one or a plurality of servers.

Further advantageous exemplary configurations of the invention can be inferred from the following detailed description of a number of exemplary embodiments of the present invention, in particular in combination with the figures. However, the figures enclosed with the application are only intended to be used for illustration purposes and not to define the scope of protection of the invention. The enclosed drawings are not necessarily true to scale and are simply intended to reflect in exemplary form the general concept of the present invention. In particular, features which are contained in the figures, should in no way be considered as a necessary element of the present invention.

### BRIEF DESCRIPTION OF THE SEVERAL VIEWS OF THE DRAWING

In the drawings:

FIG. 1 shows a block diagram of the electronic components of an exemplary embodiment of a apparatus according to the invention;

FIG. 2 shows a block diagram of an exemplary embodiment of a system according to the invention;

FIG. 3 shows a flow diagram of an example of a method according to the invention;

FIG. 4 shows a flow diagram of an example of a method according to the invention;

FIG. 5a shows a flow diagram of an example of a modified DBSCAN clustering algorithm;

FIG. 5b shows a flow diagram of an example to determine the number of data points in a Y-neighbourhood in the context of the modified DBSCAN clustering algorithm;

FIG. 6 shows an exemplary graphic representation of an ultrasonic echo signal represented by ultrasonic echo signal data;

FIG. 7 shows an exemplary graphic representation of an ultrasonic echo signal represented by a plurality of consecutive ultrasonic echo signal data blocks;

FIG. 8 shows an exemplary representation of a graphic representation of ultrasonic echo signal data; and

FIGS. 9a and 9b show an exemplary representation of a graphic representation of ultrasonic echo signal data prior to and after applying the modified DBSCAN clustering algorithm.

### DETAILED DESCRIPTION OF THE INVENTION

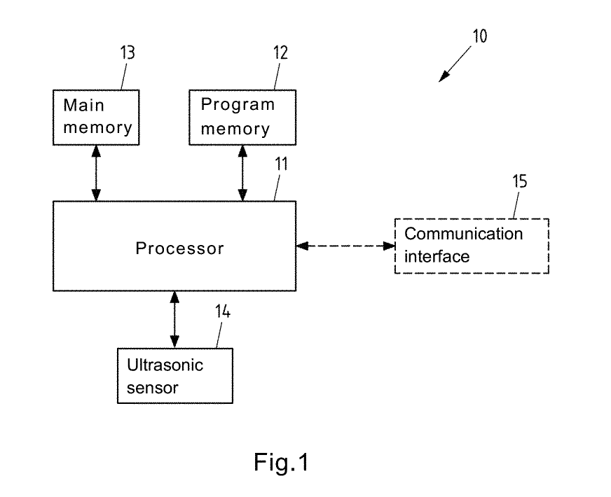

FIG. 1 is a block diagram of an exemplary embodiment of the apparatus 10 according to the invention.

Processor 11 of the apparatus 10 is, in particular configured as a microcontroller or microprocessor. Processor 11 executes program instructions which are stored in the program memory 12 and stores, for example, intermediate results or similar in the main memory 13. For example, program memory 12 is a non-volatile memory such as a flash memory, a magnetic memory, an EEPROM memory, a persistent memory such as a ROM memory and/or an optical memory. Main memory 13 is, for example, a volatile or non-volatile memory, in particular a memory with random access memory (RAM) such as a static RAM memory (SRAM), a dynamic RAM memory (DRAM).

Program memory 12 and main memory 13 are preferably arranged together with processor 11 in one module. Processor 11 is, for example, operatively connected to program memory 12 and main memory 13, for example via a bus.

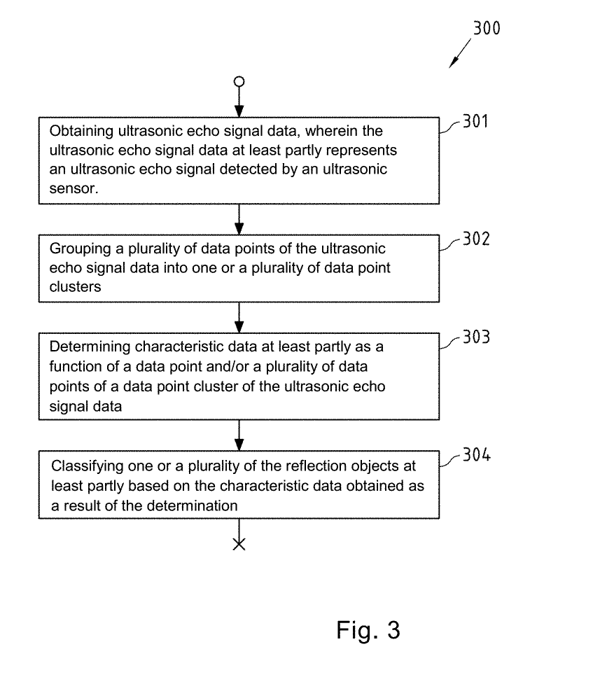

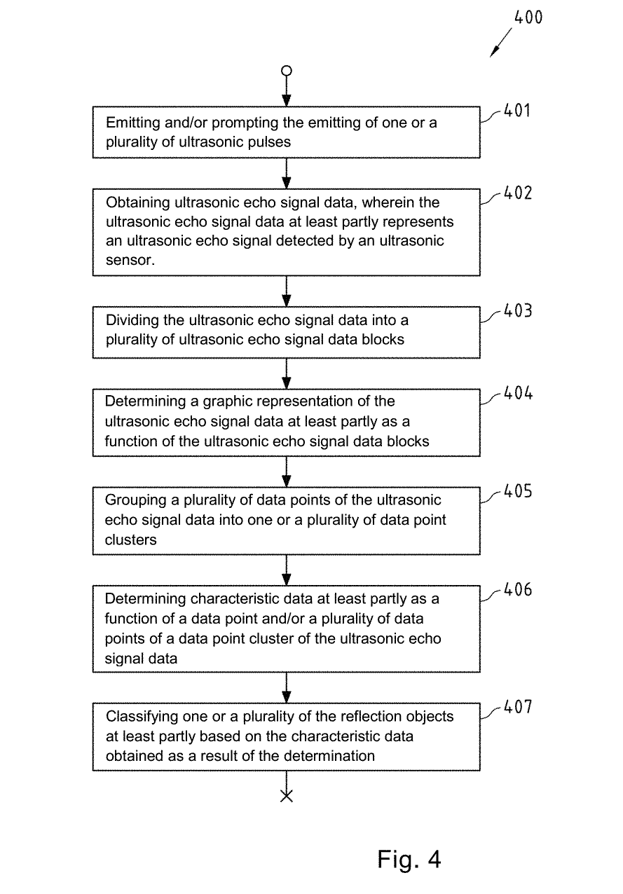

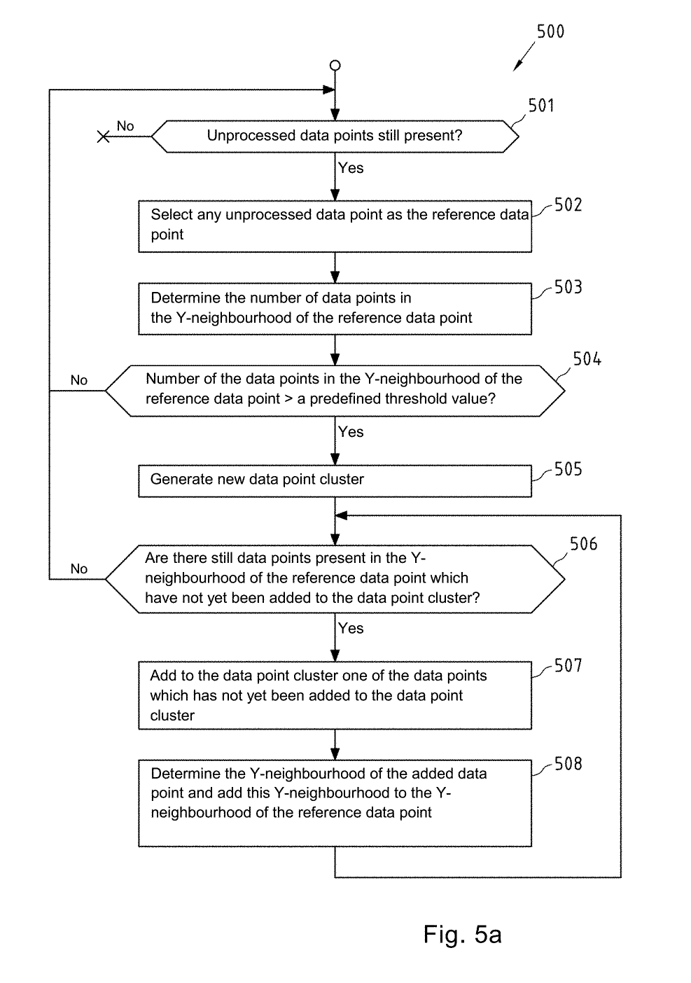

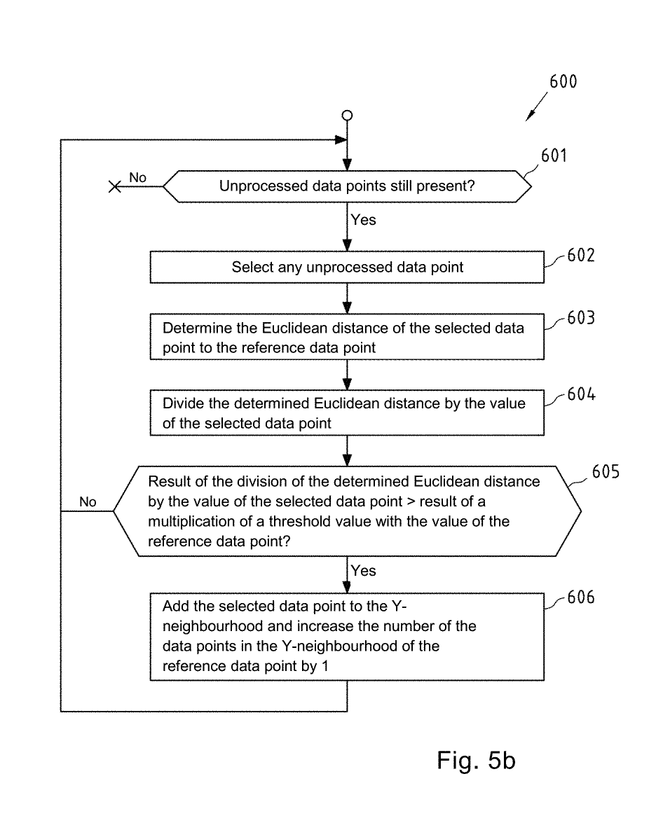

Program instructions are, for example, stored in program memory 12 which prompt the processor 11 and/or apparatus 10, when the processor 11 executes the program instructions, to at least partly perform and/or to control the method represented in FIG. 3 and/or FIG. 4 and/or FIGS. 5a and 5b.

Apparatus 10 comprises an ultrasonic sensor 14. However, embodiments are also possible in which the ultrasonic sensor 14 is not part of the apparatus 10, but rather is, for example, separate from the apparatus 10.

The ultrasonic sensor 14 is, for example, formed as a combined ultrasonic detector and ultrasonic emitter.

Accordingly, ultrasonic sensor 14 is, on the one hand, configured to detect an ultrasonic echo signal. The ultrasonic sensor 14 communicates, for example, ultrasonic echo signal data to the processor 11 which are a representation of the time curve of the signal strength of the detected ultrasonic echo signal. In order to detect the ultrasonic echo signal, the ultrasonic sensor 14 has, for example, a piezoelectric converter which converts an ultrasonic echo signal detectable at the position of the ultrasonic sensor 15 into an electric signal. The ultrasonic sensor also has, for example, additional components for processing the electric signal (e.g. one or a plurality of filters such as one or a plurality of band pass filters, a mixer such a downstream mixer, etc.) as well as for analogue-digital conversion of the electric signal and to obtain the ultrasonic echo signal data (e.g. an analogue-digital converter such as a Delta-Sigma converter and/or a parallel converter).

On the other hand, ultrasonic sensor 14 is, for example, configured to emit one or a plurality of ultrasonic pulses, for example when a corresponding control signal is obtained by processor 11 at ultrasonic sensor 14. In order to emit the ultrasonic pulses, the ultrasonic sensor 14 can also comprise a piezoelectric converter which converts an electric signal into one or a plurality of ultrasonic pulses. The same piezoelectric converter can preferably be used to emit and detect.

Processor 11 is, for example, operatively connected to ultrasonic sensor 14, for example via a bus.

The optional wireless communication interface 15 is, for example, configured to communicate according to one or a plurality of wireless communication techniques. It is assumed below for example that the wireless communication interface 15 supports communication via a local radio network and a mobile network. For example, the wireless communication interface 15 is at least partly formed by a transceiver of local radio network technology, a transceiver of mobile technology and one or a plurality of antenna. As disclosed above, an example of local radio network technology is RFID, NFC, Bluetooth and/or WLAN; and an example of mobile network technology is GSM, UMTS and/or LTE. The wireless communication interface 15 can optionally support only one of these wireless communication techniques or additional wireless and/or wired communication techniques.

The processor 11 can, for example, communicate via the wireless communication interface 15 with other apparatuses such as a server, a remote monitoring apparatus, one or a plurality of separate ultrasonic sensors and/or additional apparatuses according to the invention. Processor 11 is, for example, operatively connected to the wireless communication interface 15, for example via a bus. The wireless communication interface 15 can obtain or request information from other apparatuses and provide it to processor 11 and/or obtain information from processor 11 and send to other apparatuses. For example, processor 11 at least partly controls the communication interface 15.

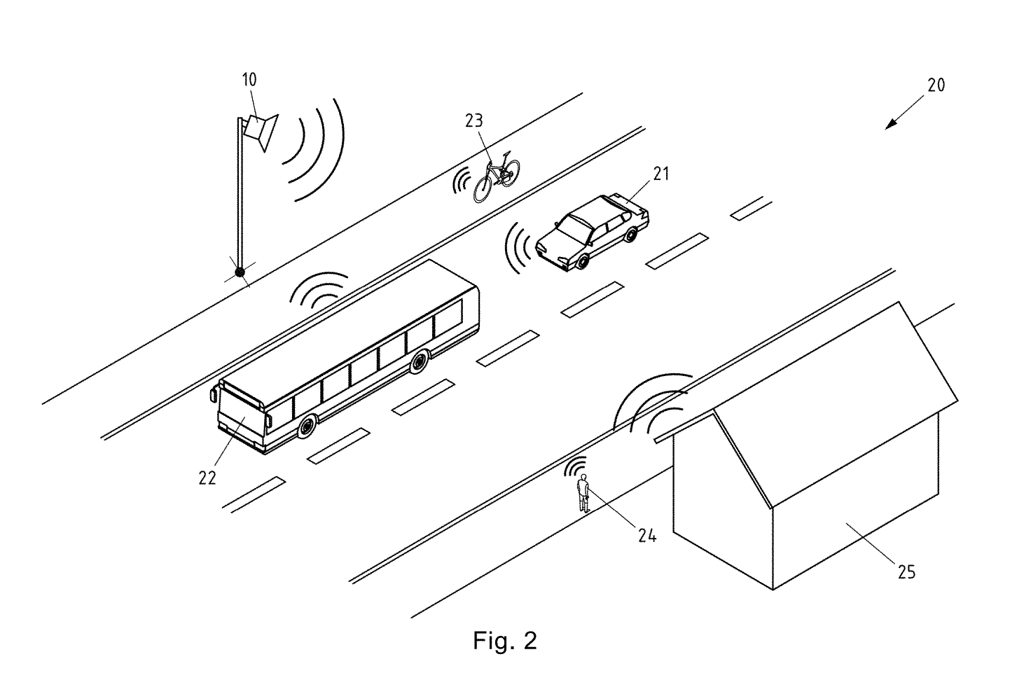

FIG. 2 is a block diagram of an exemplary embodiment of the system 20 according to the invention. The system 20 comprises the apparatus 10 with the ultrasonic sensor 14 (not represented in FIG. 2). The system 20 can optionally comprise additional apparatuses, ultrasonic sensors and/or ultrasonic emitters according to the invention as well as one or a plurality of servers.

Apparatus 10 is mounted in system 20 for example in a sidefire configuration on a mast of a streetlamp and aligned angled (e.g. inclined, i.e. neither perpendicular nor horizontal) to the street surface. Both moving objects 21, 22, 23 and 24 and also unmoving object 25 are located in the detection range of the ultrasonic sensor 15 in the exemplary situation represented in FIG. 2.

FIG. 3 is a flow diagram 300 which represents, for example, the steps of a method according to the invention. The steps represented in the flow diagram 300 are performed and/or controlled, for example, by means of the apparatus 10. The steps are, for example, performed and/or controlled at least partly by the processor 11 of the apparatus 10.

Ultrasonic echo signal data are obtained at the apparatus 10 in a step 301, wherein the ultrasonic echo signal data at least partly represents an ultrasonic echo signal detected by the ultrasonic sensor 14. The ultrasonic echo signal data are, for example, obtained at the apparatus 10 by detecting the ultrasonic echo signal by means of the ultrasonic sensor 14.

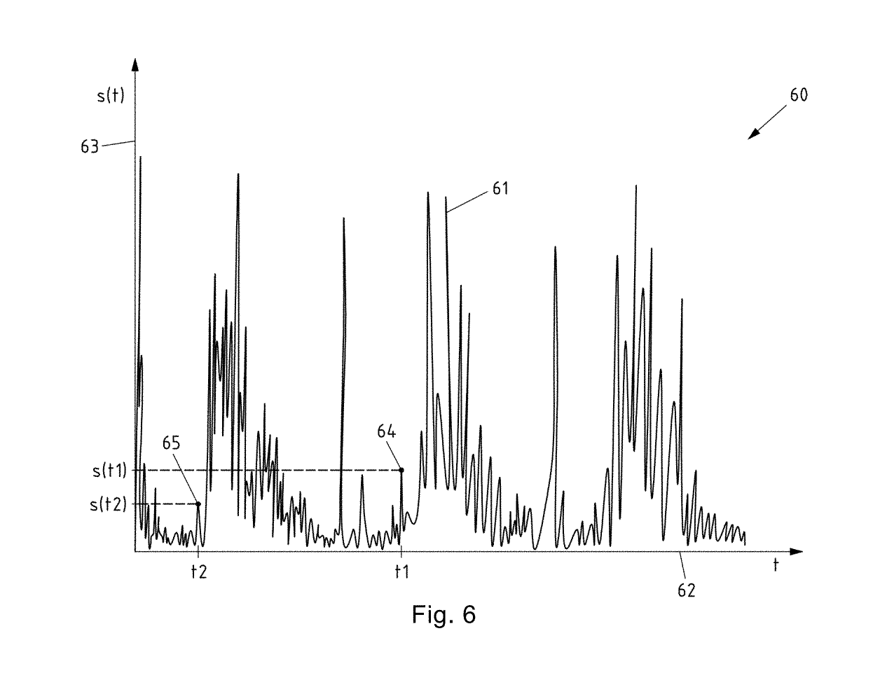

The ultrasonic echo signal data are, for example, a representation of the time curve of the signal strength of the ultrasonic echo signal detected by the ultrasonic sensor. Each data point of the ultrasonic echo signal data comprises, for example, a representation of a value of the signal strength of the detected ultrasonic echo signal at a detection time and a representation of the detection time. An exemplary graphic representation 60 of the ultrasonic echo signal 61 represented by the ultrasonic echo signal data is shown in FIG. 6. Each signal point of the ultrasonic echo signal 61 corresponds to a data point of the ultrasonic echo signal data. The ultrasonic echo signal 61 is represented in FIG. 6 as a time curve of the signal strength. Accordingly, the time t is plotted on the absicissa 62 and the signal strength s(t) on the ordinate 63.

A possible example of a first signal point corresponding to a first data point is provided with the reference numeral 64 in the graphic representation 60 of the ultrasonic echo signal 61 represented by the ultrasonic echo signal data. In this example, the first data point, for example, comprises a representation of the value of the signal strength s(t₁) and a representation of the first detection time t₁. A possible example of a signal point corresponding to a second data point is provided with the reference numeral 65 such that the second data point comprises, for example, a representation of the value of the signal strength s(t₂) and a representation of the second detection time t₂. The second detection time t₂ is chronologically earlier than the first detection time t₁. In addition, the data points of the ultrasonic echo signal data can optionally comprise further additional information such as frequency and/or phase information (e.g. the frequency spectrum per data point and/or the phase position per data point).

A plurality of data points of the ultrasonic echo signal data are grouped into one or a plurality of data point clusters in a step 302. As described above, grouping a plurality of data points of the ultrasonic echo signal data into one or a plurality of data point clusters can, in particular, comprise applying a clustering algorithm to the data points of the ultrasonic echo signal data.

Characteristic data are at least partly determined as a function of a data point and/or a plurality of data points of a data point cluster of the ultrasonic echo signal data in a step 303. As a result of the determination, the characteristic data are obtained, for example, in step 303. The characteristic data comprise, as described above, for example amplitude, frequency and/or phase information (e.g. amplitude, frequency and/or phase information of a signal portion of the ultrasonic echo signal represented by one or a plurality of data points) and/or information concerning the morphology, the pattern and/or the localisation of one or a plurality of data point clusters.

One or a plurality of the reflection objects (e.g. objects 21 to 25) located in the detection range of the ultrasonic sensor 14 are at least partly classified in a step 304 based on the characteristic data obtained as a result of the determination in step 303. For example, the characteristic data are selected such that they allow a classification of the reflection objects.

The classification comprises, for example, detecting one or a plurality of reflection objects. Detecting one or a plurality of the reflection objects should, for example, be understood as detecting the presence of one or a plurality of reflection objects in the detection range of the ultrasonic sensor 14. This can, for example, be carried out based on the data point clusters. For example, it is assumed that the data points of a data point cluster at least substantially represent signal portions of the ultrasonic signal tracing back to reflections of the ultrasonic pulse on a reflection object. Accordingly, one or a plurality of reflection objects are, for example, detected when the data points have been grouped into one or a plurality of data point clusters in step 303.

Based on the characteristic data, the reflection objects are, for example, assigned in step 304 to an object class. An object class comprises, for example, reflection objects of a determined type, such as pedestrians, cyclists or motor vehicles (e.g. motorbikes, passenger cars, trucks).

For example, the assignment of the reflection objects to an object class, as described above, can be carried out based on a predefined decision tree or by an algorithm for machine learning and/or a machine learning technique. For example, such an algorithm for machine learning obtains the characteristic data determined in step 303 as input and/or starting data.

Alternatively or additionally, a probability for the affiliation of the reflection objects to an object class is determined based on the characteristic data. The reflection objects are then, for example, assigned to the object class with the highest probability.

FIG. 4 is a flow diagram 400, which, by way of example, represents the steps of a method according to the invention. The steps represented in the flow diagram 400 are performed and/or controlled, for example, by means of the apparatus 10. The steps are, for example, performed and/or controlled at least partly by the processor 11 of the apparatus 10.

The apparatus 10 emits one or a plurality of ultrasonic pulses and/or prompts the emitting of the ultrasonic pulses in a step 401. For example, the ultrasonic pulses are emitted at regular time internals T_{R}. Alternatively or additionally, the emitting of the ultrasonic pulses is, for example, prompted at regular time intervals T_{R}. The emitted ultrasonic pulses are preferably identical. For example, the emitted ultrasonic pulses are based on a time-limited prototype pulse, which is modulated and/or frequency-shifted to an ultrasonic carrier frequency (e.g. 44 kHz).

For example, the ultrasonic pulses are emitted from the ultrasonic sensor 14 in step 401. The processor 11 actuates, for example, the ultrasonic sensor 14 to prompt the ultrasonic sensor 14 to emit the ultrasonic pulses.

Ultrasonic echo signal data are obtained at the apparatus 10 in a step 402, wherein the ultrasonic echo signal data at least partly represent an ultrasonic echo signal detected by the ultrasonic sensor 14. The ultrasonic echo signal data are, for example, obtained at the apparatus 10 by detecting the ultrasonic echo signal by means of the ultrasonic sensor 14. Step 402 corresponds, for example, to the step 301 described above in connection with the flow diagram 300 shown in FIG. 3.

As described above, the ultrasonic echo signal data are, for example, a representation of the time curve of the signal strength of the ultrasonic echo signal detected by the ultrasonic sensor 14. For example, the ultrasonic echo signal represented by the ultrasonic echo signal data comprises signal portions at least substantially tracing back to reflections of the ultrasonic pulses emitted in step 401 on moving objects (e.g. objects 21 to 24 in FIG. 2) and unmoving objects (e.g. object 25 in FIG. 2). An exemplary graphic representation 60 of the ultrasonic echo signal 61 represented by the ultrasonic echo signal data is, as described above, shown in FIG. 6.

The ultrasonic echo signal data are divided into a plurality of ultrasonic echo signal data blocks in a step 403, for example the processor 11 divides the ultrasonic echo signal data into a plurality of ultrasonic echo signal data blocks. In this case, the ultrasonic echo signal data are divided into a plurality of ultrasonic echo signal data blocks such that the ultrasonic echo signal data blocks represent consecutive time periods of identical time period length of the time curve of the value of the signal strength of the detected ultrasonic echo signal, wherein a first ultrasonic echo signal data block comprises the first data point and a second ultrasonic echo signal data block comprises the second data point.

For example, each of the time periods starts with the emission time of an ultrasonic pulse. This has the effect in the present case of the time period length of each of the time periods, for example, corresponding to the time interval T_{R} between the emission times of two consecutive ultrasonic pulses. The time curve of the signal strength of the detected ultrasonic echo signal represented by an ultrasonic echo signal data block is also in this case at least substantially determined by reflections of the ultrasonic pulse emitted at the beginning of the respective time period and is thus, for example, also designated below as an ultrasonic pulse response.

The beginning of a time period can, for example, take place by knowing exactly the emission times. For example, the processor 11 knows the emission time of the ultrasonic pulses when it actuates the ultrasonic sensor 14 in order to prompt the ultrasonic sensor 14 to emit the ultrasonic pulses. Alternatively or additionally, corresponding emission time data, which represent one or a plurality of emission times of one or a plurality of ultrasonic pulses, can be stored in program memory 12. Alternatively or additionally, the emission times of an ultrasonic pulse can also be determined. For example, when the ultrasonic sensor 14 is a combined ultrasonic detector and ultrasonic emitter, it can be determined by an analysis of the remaining talkback of an emitted ultrasonic pulse in the ultrasonic detector (e.g. talkback concerning common components of the ultrasonic detector and the ultrasonic emitter such as a duplexer).

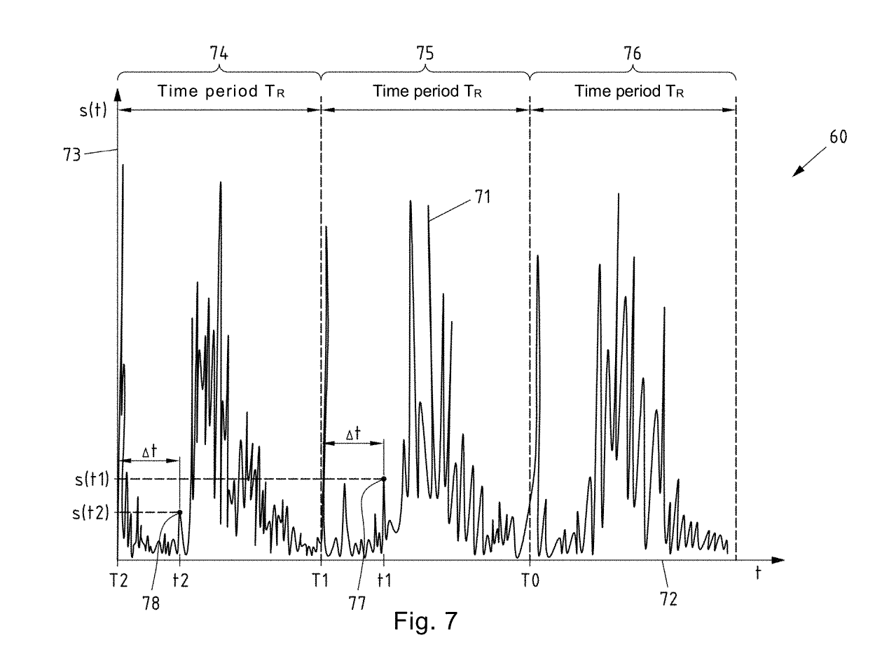

An exemplary graphic representation 70 of the ultrasonic echo signal 71 represented by three consecutive ultrasonic echo signal data blocks is shown in FIG. 7. The ultrasonic echo signal 71 corresponds to the ultrasonic echo signal 61 represented in FIG. 6. Accordingly, in FIG. 7 time t is plotted on the abscissa 72 and the signal strength s(t) on the ordinate 73. The three consecutive time periods 74, 75 and 76 each have the time period length T_{R} selected to be constant here by way of example and start with one of the emission times T₀, T₁ and T₂ of an ultrasonic pulse emitted in step 401. These time periods 74, 75 and 76 and the time curve of the signal strength of the ultrasonic echo signal 71 shown therein each correspond to an ultrasonic echo signal data block.

The ultrasonic echo signal data can then, for example, be standardised in an optional step not represented in flow diagram 400. As described above, standardising the ultrasonic echo signal data according to a first aspect should, for example, be understood as signal portions tracing back to reflections of one or a plurality of previously emitted ultrasonic pulses on unmoving objects (e.g. object 25 in FIG. 2) being at least partly reduced in the standardised ultrasonic echo signal represented by the standardised ultrasonic echo signal data with respect to the detected ultrasonic echo signal. Standardising the ultrasonic echo signal data according to this first aspect is described below. In order to obtain ultrasonic echo signal data standardised according to the second aspect, the difference between the ultrasonic echo signal data obtained in step 402 and the ultrasonic echo signal data standardised according to the first aspect can then, for example, be formed.

For example, standardising according to the first aspect of at least one first data point of the ultrasonic echo signal data comprises selecting at least one second data point at least partly as a function of the first data point and determining a standardised first data point based on at least the first and the second data point. Different algorithms are possible for this purpose of which one possible algorithm is described by way of example below.

For example, the second data point is determined and/or selected such that it is associated with the same signal runtime Δt as the first data point and/or is located in the second ultrasonic echo signal data block at the same position as the first data point in the first ultrasonic echo signal data block. In addition to the second data point, additional data points can be determined and/or selected such that they are associated with the same signal runtime Δt as the first data point and/or are located in their respective ultrasonic echo signal data block at the same position as the first data point in the first ultrasonic echo signal data block.

A possible example of a signal point corresponding to the first data point is provided with the reference numeral 77 in the graphic representation 70 of the ultrasonic echo signal 71 represented by the ultrasonic echo signal data. In this example, the first data point, for example, comprises a representation of the value of the signal strength s(t₁) and a representation of the first detection time t₁. A possible example of a signal point corresponding to the second data point is provided with the reference numeral 78 such that the second data point comprises, for example, a representation of the value of the signal strength s(t₂) and a representation of the second detection time t_{2.} The second detection time t₂ is chronologically earlier than the first detection time t₁.

The time difference between the first detection time t₁ and the first emission time T₁ and the time difference between the second detection time t₂ and the second emission time T₂ corresponds to Δt. In this case, Δt corresponds to the signal runtime of the ultrasonic pulse emitted at the start of the respective time period. The distance d of the reflected object can be determined from the signal runtime Δt, provided there is no multiple reflection (e.g. with the following formula:

$$d = \frac{Δ t * v}{2} ,$$

with speed of sound v). Accordingly, both values of the signal strength s(t₁) and s(t₂), provided there are no multiple reflections, trace back to a reflection of the ultrasonic pulse emitted at the start of the respective time period on an object at the same distance d from the ultrasonic sensor 14.

The second data point and, if necessary, additional data points can, for example, be determined at least partly as a function of a window function h(t). For example, the window function h(t=T₁) predefines a time section as a function of the start of the first time period T₁ (i.e. of the first emission time T₁) in which the second data point and, if necessary, the additional data points are present. In this case, the window function h(t=T₁) can predefine a past time section and/or a future time section (e.g. by a delay of the real-time processing of the ultrasonic echo signal data).

The average value s̅(T₁, Δt) and the variance σₛ²(T₁, Δt) are then, for example, determined for the values of the signal strength (e.g. s(t₁) with t₁=T₁+Δt for the first data point, s(t₂) for the second data point) of the detected ultrasonic echo signal represented by the first data point and the second data point and, if necessary, the additional data points. In this case, the window function h(t=T₁) can predefine a weighting of the values of the signal strength represented by the first data point and the second data point and, if necessary, the additional data points. The first data point sₙ(t₁) standardised according to the first aspect can then, for example, be determined corresponding to the following formula:

$${s}_{n} ( {t}_{1} ) = \frac{s ( {t}_{1} ) - \overline{s} ( {T}_{1} , Δ t )}{\sqrt[2]{{σ}_{s}^{2} ( {T}_{1} , Δ t )}}$$

This has the effect of the average reflection level and furthermore the fluctuation value, which is also distance-dependent, being at least partly reduced and/or compensated. As a result, compensation and/or reduction of the statistical environmental effects is achieved, i.e. of the effects tracing back to reflections on unmoving and/or virtually-unmoving objects.

This is, for example, advantageous in order to minimise the effects and disruptions resulting from the change both of the objects and the environment in the detection range of the ultrasonic sensor 15. These can, e.g., be slight changes (e.g. moving trees, opening windows, etc.), but also objects which are continuously added into the environment and removed therefrom (e.g. parking vehicles). In order to take these factors into account, a time window can be used (weighted function of a plurality of ultrasonic echo signal data blocks), based on which for example characteristics of the environment can be taken into account (e.g. base reflections of the environment, the ground and stationary objects) and the general changeability of the environment (size of the fluctuation of the reflections present on all sides, such as e.g. caused by the movement of the trees, vibrations, sensor errors and disruptions). Individual objects (e.g. parking cars), which continuously change the environment, can also be taken into account by means of computer following detection.

For example, the above-described standardising of at least the first data point is repeated for each data point of the ultrasonic echo signal data. For example, the first data point is, in this case, the data point to be standardised according to the first aspect. For example, the second data point (and if necessary each of the additional data points) is determined and/or selected as a function of the first data point.

Standardised ultrasonic echo signal data are obtained as a result of standardisation (e.g. according to the first aspect), comprising at least the standardised first data point. If standardising is repeated for each data point of the ultrasonic echo signal data, standardised ultrasonic echo signal data are obtained as a result of standardisation (e.g. according to the first aspect), comprising the standardised data points (e.g. exclusively comprising standardised data points). In this case, the following steps of the flow diagram are, for example, continued with the standardised ultrasonic echo signal data. Standardisation can, alternatively or additionally, also be carried out at a different time (e.g. after step 404).

Alternatively or in addition to the standardisation, additional analysis and compensation algorithms can, for example, be applied to the ultrasonic echo signal data in one or a plurality of additional optional steps such as for example algorithms for multiple reflection analysis/compensation and/or expansion analysis/compensation.

A graphic representation of the ultrasonic echo signal data is determined in a step 404 at least partly as a function of the ultrasonic echo signal data blocks. The graphic representation is, for example, a two-dimensional representation of the ultrasonic echo signal data. For example, the graphic representation is and/or comprises a pixel arrangement with pixels arranged in a grid.

The graphic representation and/or an ultrasonic echo signal data structure that can be graphically represented is, for example, obtained as a result of the determination in step 404. As described above, such an ultrasonic echo signal data structure that can be graphically represented is, for example, a two-dimensional data field and/or a data array and/or a graphic file (e.g. a graphic file in an image data format such as the bitmap format, BMP format).

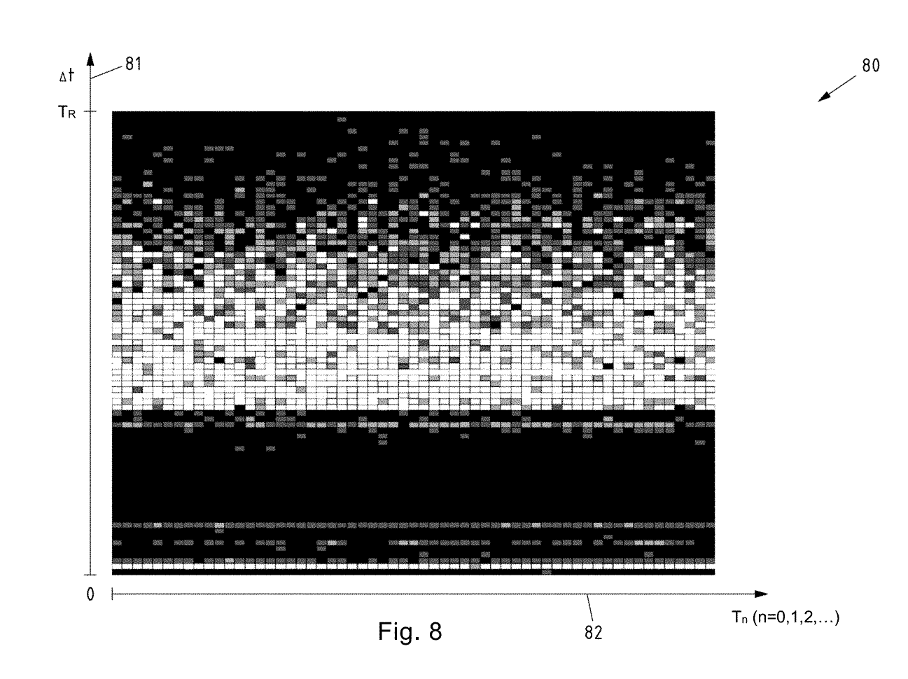

FIG. 8 shows an exemplary representation of a graphic representation of ultrasonic echo signal data. The graphic representation in FIG. 8 is a pixel arrangement 80 with pixels arranged in a grid. For example, each pixel of the pixel arrangement 80 is determined as a function of a data point of the ultrasonic echo signal data. For example, the grey scale of a pixel is determined as a function of the value of the signal strength (alternatively also frequency and/or phase) represented by the respective data point. In this case, all data points of an ultrasonic echo signal data block are represented by the pixels of the pixel arrangement 80 arranged in a grid column of the grid, and data points of consecutive ultrasonic echo signal data blocks are represented by the pixels of the pixel arrangement 80 arranged in consecutive grid columns of the grid. For the case described above where each time period represented by an ultrasonic echo signal data block starts with the emission time of an ultrasonic pulse, each grid column of the grid of the pixel arrangement 80 thus, for example, represents an ultrasonic pulse response of a previously emitted ultrasonic pulse.

For example, the signal runtime Δt is plotted on the ordinate 81 running in the direction of the grid columns with the maximum value T_{R}. As described above, the distance d of the reflection object can be determined from the signal runtime Δt, provided there is no multiple reflection (e.g. with the formula:

$$d = \frac{Δ t * v}{2} ,$$

with speed of sound v). The ordinate can thus also be designated as the pulse response axis, distance axis or signal runtime axis. The emission times (e.g. T₀, T₁, T₂) of the ultrasonic pulses are, for example, plotted as discrete times on the abscissa 82. It thus constitutes the number of ultrasonic pulse responses detected to an ultrasonic pulse and can also be designated as a time axis.

Accordingly, the position of each pixel in FIG. 8 is determined by the emission time of the ultrasonic pulse, which determines the start of the time period of the ultrasonic echo signal data block of the respective data point, and the signal runtime associated with the respective data point. The grey scale of each pixel is also determined as a function of the value of the signal strength represented by the respective data point.

The ultrasonic echo signal data can thus be further processed in this two-dimensional representation e.g. with image processing algorithms.

The graphic representation is, for example, the starting basis for the additional steps of the flow diagram 400.

A plurality of data points of the ultrasonic echo signal data are grouped into one or a plurality of data point clusters in a step 405. For example, grouping of a plurality of data points of the ultrasonic echo signal data into one or a plurality of data point clusters is at least partly based on the graphic representation (e.g. the above-described pixel arrangement) determined in step 404 and/or an ultrasonic echo signal data structure which can be graphically represented and obtained as a result of determining the graphic representation in step 404. Grouping of a plurality of data points of the ultrasonic echo signal data into one or a plurality of data point clusters comprises, for example, applying a clustering algorithm to the graphic representation (e.g. the above-described pixel arrangement) and/or an ultrasonic echo signal data structure which can be graphically represented and obtained as a result of determining the graphic representation.

The clustering algorithm can, as described above, for example, be a hierarchical, a density-based or a partitioned clustering algorithm as well as a combination of different clustering algorithms. An example of a density-based clustering algorithm is the DBSCAN (Density-Based Spatial Clustering of Applications with Noise) algorithm. A flow diagram 500 of a modified DBSCAN clustering algorithm is represented in FIG. 5a as an example of a clustering algorithm. Data points are, for example, grouped into one or a plurality of data point clusters by selecting a suitable clustering algorithm which represent signal portions of the ultrasonic echo signal tracing back at least substantially to reflections on a determined reflection object. This is, for example, advantageous in order to be able to distinguish and evaluate (e.g. by determining characteristic data in step 406) the signal portions tracing back to reflections on different reflection objects in the detection range in the ultrasonic echo signal represented by the ultrasonic echo signal data.

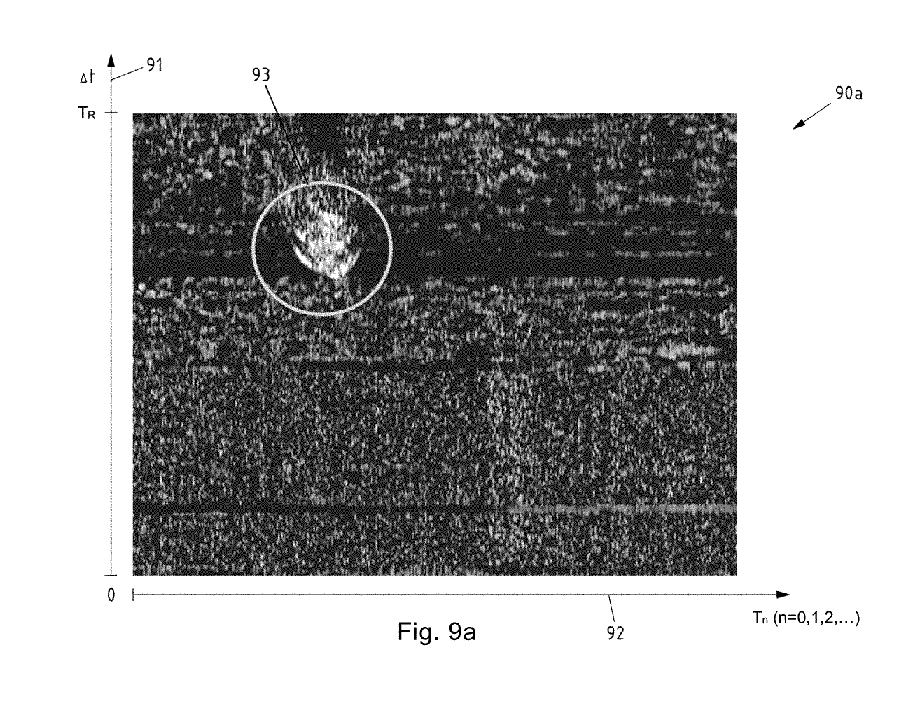

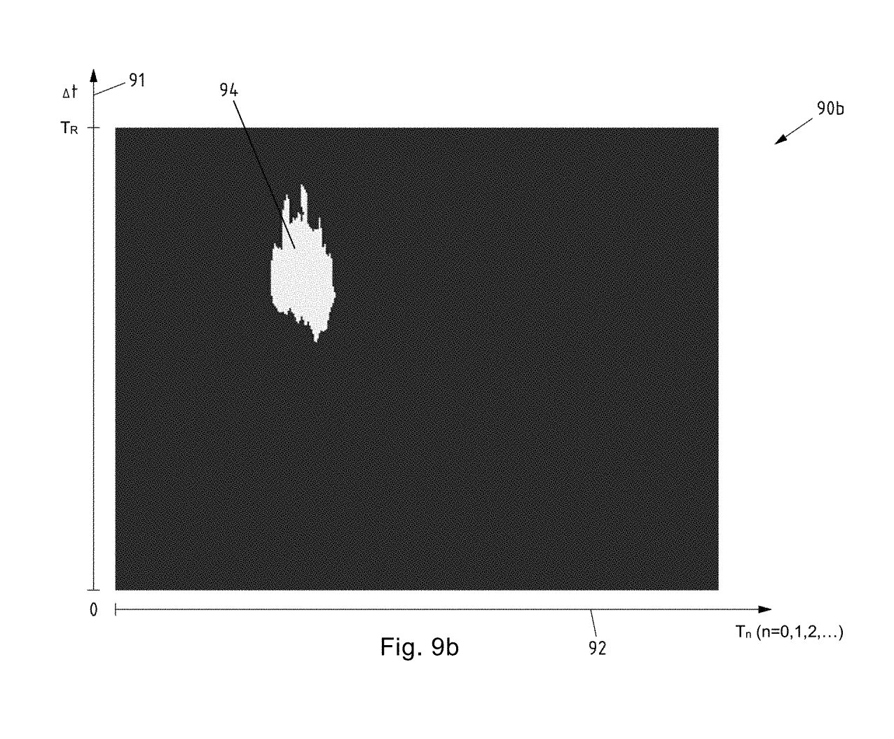

FIGS. 9a and 9b show an exemplary representation of a graphic representation of ultrasonic echo signal data prior to and after applying the modified DBSCAN clustering algorithm represented in FIG. 5a; The graphic representation in FIG. 9a is, like FIG. 8, a pixel arrangement 90a with pixels arranged in a grid and directed at the representation in FIG. 8. Accordingly, the signal runtime Δt is plotted on the ordinate 91 running in the direction of the grid columns with the maximum value T_{R}. The emission times (e.g. T₀, T₁, T₂) of the ultrasonic pulses are, for example, plotted as discrete times on the abscissa 92. Pixels are represented inside the marking 93 which represent a signal portion of an ultrasonic echo signal represented by ultrasonic echo signal data tracing back at least substantially to the reflection on a determined reflection object. The result of the application of the modified DBSCAN clustering algorithm represented in FIG. 5a to these ultrasonic echo signal data is represented in FIG. 9b. The data points located inside the marking 93 have been grouped at least partly into the data point cluster 94.

Characteristic data are at least partly determined as a function of a data point and/or a plurality of data points of a data point cluster of the ultrasonic echo signal data in a step 406. In this case, the data point clusters are, for example, the data point clusters obtained as a result of the grouping in step 405. Step 406 corresponds, for example, to the step 303 described above in connection with the flow diagram 300 shown in FIG. 3.

As described above, the characteristic data comprise, for example, amplitude, frequency and/or phase information determined as a function of one or a plurality of data points (e.g. a plurality of data points of a data point cluster, e.g. of the data point cluster 94).

Amplitude information can, for example, be obtained by determining an average value of the amplitudes (e.g. an average value of the signal strength) of the signal portion of the ultrasonic echo signal represented by one or a plurality of data points (e.g. a plurality of data points of a data point cluster).

Frequency information can, for example, be obtained by determining a frequency spectrum of the signal portion of the ultrasonic echo signal represented by one or a plurality of data points of a data point cluster and/or a frequency difference between the frequency of the signal portion of the ultrasonic echo signal represented by one or a plurality of data points (e.g. a plurality of data points of a data point cluster) and the frequency of a previously-emitted ultrasonic pulse.

Phase information can, for example, be obtained by determining a phase change. For example, such a phase change can be determined by the comparison of the phases of the signal portions of the ultrasonic echo signal represented by one or a plurality of data points (e.g. the signal points 77 and 78) of consecutive ultrasonic echo signal data blocks (e.g. the ultrasonic echo signal data blocks 74 and 75).

Alternatively or additionally, the characteristic data can comprise, as also described above, information concerning the reflection energy and/or signal runtime of the signal portion, represented by a data point cluster (e.g. a data point cluster 94) (e.g. tracing back at least substantially to reflections on a reflection object) of the ultrasonic echo signal represented by the ultrasonic echo signal data.

Information concerning the reflection energy can, for example be obtained by determining the value of the energy of the signal portion, represented by a data point cluster (e.g. tracing back at least substantially to reflections on a reflection object), of the ultrasonic echo signal represented by the ultrasonic echo signal data.

Information concerning the signal runtime can, for example, be obtained by determining the signal runtime of the signal portion, represented by one or a plurality of data points of a data point cluster (e.g. tracing back at least substantially to reflections on a reflection object), of the ultrasonic echo signal represented by the ultrasonic echo signal data.

The characteristic data can, as described above, also describe, for example, characteristic properties of the data point clusters. This includes, for example, information concerning localisation, distribution, form, morphology, pattern and expansion of a data point cluster.

In addition, the characteristic data can comprise further additional information which is, for example, determined at least partly as a function of differently processed ultrasonic echo signal data (e.g. without or with standardisation, without or with expansion compensation, without or with multiple reflection compensation).

The characteristic data are obtained, for example, as a result of the determination in step 406.

The ultrasonic echo signal data can then, for example, be fused in an optional step, not represented in flow diagram 400, with additional ultrasonic echo signal data and/or additional characteristic data. Alternatively or additionally, fusing can also be carried out at a different point, for example, prior to step 403 or prior to step 406.

For example, the additional ultrasonic echo signal data can represent an ultrasonic echo signal detected by another ultrasonic sensor. Alternatively or additionally, the additional ultrasonic echo signal data can, for example, represent the time curve of the signal strength of an additional ultrasonic echo signal which comprises signal portions tracing back at least substantially to reflections of ultrasonic pulses of a different ultrasonic emitter and/or ultrasonic sensor.

Fusing the ultrasonic echo signal data with additional ultrasonic echo signal data should, for example, be understood as the ultrasonic echo signal data being compared, combined and/or augmented with the additional ultrasonic echo signal data. Accordingly, fusing the characteristic data with additional characteristic data should be understood as the characteristic data being compared, combined and/or augmented with the additional characteristic data.

One or a plurality of the reflection objects in the detection range of the ultrasonic sensor 14 are at least partly classified in a step 407 based on the characteristic data obtained as a result of the determination. Step 407 corresponds, for example, to the step 304 described above in connection with the flow diagram 300 shown in FIG. 3.

Location and/or movement information of one or a plurality of the reflection objects can also, for example, be estimated and/or determined in step 407. Location information (e.g. a location vector and/or a distance) of a reflection object can, for example, be estimated (e.g. determined) based on the signal runtime of a signal portion, at least substantially reflected by the reflection object, of the ultrasonic echo signal represented by the ultrasonic echo signal data. Movement information (e.g. a movement vector, a direction and/or a speed) can, for example, be estimated (e.g. determined) based on frequency and/or phase information of a signal portion, at least substantially reflected by the reflection object, of the ultrasonic echo signal represented by the ultrasonic echo signal data.

The results obtained in step 407 are then, for example, provided for one or a plurality of applications. For example, the results are provided for an application for parking space monitoring and/or for traffic counting and/or monitoring. The respective object class (e.g. vehicle type), obtained as a result of the classification, of the reflection objects detected as moving can, for example be provided for such traffic counting and/or monitoring. For example, traffic and/or vehicle density of the lanes located in the detection range of the ultrasonic sensor can be determined based on this. The respective object class (e.g. the respective traffic object class) obtained as a result of the classification as well as location information of the detected reflection objects are, for example, provided for such parking space monitoring. The status (e.g. occupied or free) of a parking space located in the detection range of the ultrasonic sensor can, for example, be determined at least partly based on the provided results and, for example, additional information concerning the parking space (e.g. location information, size information, etc.) and/or previously provided results. For example, it is determined that the parking space is occupied if an object of a predefined object class is detected at the location of the parking space for a predefined time period. Additional possible applications are traffic logic, forecasting, decision level, visualisation for users (e.g. customers or users).

The applications can be carried out both locally for example by the apparatus 10 and by one or a plurality of additional apparatuses. These additional apparatuses may, for example, be a server (e.g. a cloud and/or backend server) and/or one or a plurality of additional apparatuses 10 and/or a control apparatus (e.g. a control apparatus for controlling a light means such as an ICE Gateway operated by the company, ICE Gateway GmbH).

The results obtained in step 407 can, alternatively or additionally, be used as feedback for regulating the pre-processing (e.g. in the preceding steps 401 to 406) of the ultrasonic echo signal data and/or the ultrasonic echo signal represented by the ultrasonic echo signal data.

FIG. 5a shows a flow diagram 500 which represents, by way of example, the steps of a modified DBSCAN algorithm. The steps represented in the flow diagram 500 are performed and/or controlled, for example, by means of the apparatus 10. The steps are, for example, performed and/or controlled at least partly by the processor 11 of the apparatus 10.

The steps of the flow diagram 500 are, for example, applied to ultrasonic echo signal data in order to group the data points of the ultrasonic echo signal data into data point clusters.

It is initially checked in a step 501 whether data points that are still unprocessed are present. In this case, unprocessed data points are, for example, data points which have not yet been taken into account in the steps of the flow diagram 500. If there are no unprocessed data points present, the flow diagram 500 ends.

Otherwise, any data point of the unprocessed data points is selected in a step 502 as a reference data point and then the number of the data points is determined in a Y-neighbourhood of the reference data point (see step 503). The determination of the number of the data points in a Y-neighbourhood of the reference data point is, for example, represented in FIG. 5b.

It is checked in a step 504 whether the number of the data points in the Y-neighbourhood of the reference data point is greater than a predefined threshold value. The threshold value is, for example, between 5 and 50, preferably between 10 and 40, particularly preferably between 15 and 30, for example the threshold value is 20. If the number of the data points in Y-neighbourhood of the reference data point is not greater than the predefined threshold value, the flow diagram 500 is continued with the step 501. Otherwise, a new data point cluster is generated in step 505.

It is checked in a step 506 whether data points are still present in the Y-neighbourhood of the reference data point, which have not yet been added to the data point cluster generated in step 505. If no data point is present in Y-neighbourhood of the reference data point, the flow diagram 500 is continued with the step 501.

Otherwise, a data point not yet added to the data point cluster is added to the data point cluster in step 507. The Y-neighbourhood of the added data point is then determined in a step 508 and this Y-neighbourhood is added to the Y-neighbourhood of the reference data point. In other words, the Y-neighbourhood of the reference data point is expanded by the Y-neighbourhood of the data point added in step 507. The flow diagram 500 is then continued with step 506.

As described above, FIGS. 9a and 9b show an exemplary representation of a graphic representation of ultrasonic echo signal data prior to and after applying the modified DBSCAN clustering algorithm represented in FIG. 5a.

FIG. 5b shows a flow diagram 600 which represents, for example, the steps for determining the number of data points in the Y-neighbourhood of a reference data point. The steps represented in the flow diagram 600 are performed and/or controlled, for example, by means of the apparatus 10. The steps are, for example, performed and/or controlled at least partly by the processor 11 of the apparatus 10.

The steps of the flow diagram 600 are, for example, performed in step 503 of the flow diagram 500 to determine the number of the data points in the Y-neighbourhood of a reference data point.

It is checked in a step 601 whether data points that are still unprocessed are present. In this case, unprocessed data points are, for example, data points which have not yet been taken into account in the steps of the flow diagram 600. If there are no unprocessed data points present, the flow diagram 600 ends.

Otherwise, any unprocessed data point is selected in a step 602 and then the Euclidean distance of the data point selected in step 602 to the reference data point is determined (see step 603).

The Euclidean distance determined in step 603 is separated in a step 604 by the value of the data point selected in step 602.

The value obtained as a result of the calculation in step 604 is compared in a step 605 with the value obtained as a result of a multiplication of a threshold value with the value of the reference data point. The threshold value is, for example, between 0 and 5, preferably between 0 and 1, particularly preferably between 0.1 and 0.2, for example, the threshold value is 0.15. If the value obtained as a result of the calculation in step 604 is greater than or equal to the value obtained as a result of the multiplication of the threshold value with the value of the reference data point, the flow diagram 600 is continued with the step 601.

Otherwise, the data point selected in step 602 is added in step 606 to the Y-neighbourhood of the reference data point and the number of the data points increases by 1 in the Y-neighbourhood of the reference data point. The flow diagram 600 is then continued with step 601.

Determined embodiments of the invention allow, for example the novel use of ultrasonic sensors to monitor complex environments (e.g. environments outdoors, in particular street traffic). New configurations are possible by means of the evaluation of not only one, but rather all reflections located in the coverage range, such as for example sidefire arrangement from the side of the street to monitor a plurality of lanes. The most varied target applications such as traffic monitoring or also parking space monitoring are also possible at the same time with a sensor or a sensor combination. In this case, the evaluation can be facilitated through the novel internal or graphic representation (e.g. in the form of a pixel arrangement), which allows simultaneous analysis of the time and spatial connection for the ultrasonic sensor evaluation.

The use of ultrasonic sensors constitutes the much improved alternative to the sensors used in the prior art such as for example radar sensors for ecological and economical reasons. The results can thus even be improved and optimised through the higher number of a plurality of distributed sensors at a plurality of optional points.

The exemplary embodiments of the present invention described in this specification should also be understood as being disclosed in all combinations with each other. In particular, the description of a feature included by an embodiment, provided the opposite is not explicitly explained, should also not be understood in the present case as the feature being necessary or essential for the function of the exemplary embodiment. The sequence of the method steps in the individual flow diagrams outlined in this specification is not absolutely necessary, alternative sequences of the method steps are conceivable. The method steps can be implemented in a different manner, thus an implementation in software (by program instructions), hardware or a combination of the two in order to implement the method steps is conceivable.

Terms used in the claims such as “comprise”, “have”, “contain”, “include” and the like do not exclude additional elements or steps. The wording “at least partly” includes both the case of “partly” and also the case of “fully”. The wording “and/or” should be understood as both the alternative and the combination being disclosed, i.e. “A and/or B” means “(A) or (B) or (A and B)”. A plurality of units, individuals or the like means multiple units, individuals or the like in the context of this specification. The use of the indefinite article does not exclude a plurality. An individual apparatus can perform the functions of a plurality of units or apparatuses mentioned in the claims. Reference numerals indicated in the claims should not be considered as limitations of the means and steps used.

1. Method comprising:
obtaining ultrasonic echo signal data, wherein the ultrasonic echo signal data comprises a plurality of data points, wherein the ultrasonic echo signal data at least partly represents an ultrasonic echo signal detected by an ultrasonic sensor and wherein the ultrasonic echo signal comprises signal portions tracing back to reflections on one or a plurality of reflection objects,
grouping a plurality of data points of the ultrasonic echo signal data into one or a plurality of data point clusters,
determining characteristic data at least partly as a function of a data point or a plurality of data points of a data point cluster of the ultrasonic echo signal data,
classifying one or a plurality of the reflection objects at least partly based on the characteristic data obtained as a result of the determination.

2. Method according to claim 1, wherein each data point of the ultrasonic echo signal data represents the value of the signal strength of the detected ultrasonic echo signal at a detection time.

3. Method according to claim 1, wherein the ultrasonic sensor is stationary.

4. Method according to claim 1, the method further comprising:
emitting or prompting the emitting of one or a plurality of ultrasonic pulses, wherein the reflections at least substantially comprise reflections of the emitted ultrasonic pulses on the reflection objects.

5. Method according claim 1, the method further comprising:
dividing the ultrasonic echo signal data into a plurality of ultrasonic echo signal data blocks, wherein the ultrasonic echo signal data blocks represent consecutive time periods of equal time period length of a time curve of a value of the signal strength of the detected ultrasonic echo signal.

6. Method according to claim 5, the method further comprising:
determining a graphic representation of the ultrasonic echo signal data at least partly as a function of the ultrasonic echo signal data blocks.

7. Method according to claim 6, wherein the graphic representation is or comprises a pixel arrangement with pixels arranged in a grid.

8. Method according to claim 7, wherein the pixels of each grid column of the grid are determined as a function of the data points of a respective ultrasonic echo signal data block of the ultrasonic echo signal data blocks.

9. Method according to claim 6, wherein the grouping of a plurality of data points of the ultrasonic echo signal data into one or a plurality of data point clusters is at least partly based on the graphic representation.

10. Method according to claim 1, wherein the grouping of a plurality of data points of the ultrasonic echo signal data into one or a plurality of data point clusters comprises applying a clustering algorithm to the data points of the ultrasonic echo signal data.

11. Method according to claim 1, wherein the characteristic data comprise at least one or a plurality of the following information:
amplitude, frequency or phase information,
information concerning localisation, distribution, form, morphology, pattern or expansion of a data point cluster,
information concerning reflection energy of the signal portion, represented by the data points of a data point cluster, of the ultrasonic echo signal represented by the ultrasonic echo signal data,
information concerning a signal runtime of the signal portion, represented by the data points of a data point cluster, of the ultrasonic echo signal represented by the ultrasonic echo signal data.

12. Method according to claim 1, wherein the classifying of one or a plurality of the reflection objects comprises one or a plurality of the following steps:
detecting one or a plurality of the reflection objects,
assigning one or a plurality of reflection objects to an object class,
determining a probability for the affiliation of one or a plurality of reflection objects to an object class.

13. Method according to claim 1, the method further comprising:
estimating at least one of location or movement information of one or a plurality of the reflection objects.

14. Method according to claim 1, wherein the classifying of the ultrasonic echo signal data is carried out at least partly as a function of an algorithm for machine learning or a machine learning technique.

15. Method according to claim 1, the method further comprising:
fusing the ultrasonic echo signal data with additional ultrasonic echo signal data, or
fusing the characteristic data with additional characteristic data, wherein the additional characteristic data have been determined at least partly as a function of a data point or a data point cluster of additional ultrasonic echo signal data.

16. Method according to claim 1, the method further comprising:
standardising the ultrasonic echo signal data.

17. Computer-readable memory medium having a computer program stored thereon, comprising program instructions, which prompt a processor to perform or control, when the computer program runs on the processor:
obtaining ultrasonic echo signal data, wherein the ultrasonic echo signal data comprises a plurality of data points, wherein the ultrasonic echo signal data at least partly represents an ultrasonic echo signal detected by an ultrasonic sensor and wherein the ultrasonic echo signal comprises signal portions tracing back to reflections on one or a plurality of reflection objects,
grouping a plurality of data points of the ultrasonic echo signal data into one or a plurality of data point clusters,
determining characteristic data at least partly as a function of a data point or a plurality of data points of a data point cluster of the ultrasonic echo signal data,
classifying one or a plurality of the reflection objects at least partly based on the characteristic data obtained as a result of the determination.

18. Apparatus, comprising at least one processor and at least one memory with program instructions, wherein the memory and the program instructions are configured, together with the at least one processor, to prompt the apparatus to perform:
obtaining ultrasonic echo signal data, wherein the ultrasonic echo signal data comprises a plurality of data points, wherein the ultrasonic echo signal data at least partly represents an ultrasonic echo signal detected by an ultrasonic sensor and wherein the ultrasonic echo signal comprises signal portions tracing back to reflections on one or a plurality of reflection objects,
grouping a plurality of data points of the ultrasonic echo signal data into one or a plurality of data point clusters,
determining characteristic data at least partly as a function of a data point or a plurality of data points of a data point cluster of the ultrasonic echo signal data,
classifying one or a plurality of the reflection objects at least partly based on the characteristic data obtained as a result of the determination.

19. Apparatus according to claim 18, wherein the apparatus is part of a control apparatus for controlling a light means or is a control apparatus for controlling a light means.

20. Apparatus according to claim 18, wherein the memory and the program instructions are further configured, together with the at least one processor, to prompt the apparatus to perform:
dividing the ultrasonic echo signal data into a plurality of ultrasonic echo signal data blocks, wherein the ultrasonic echo signal data blocks represent consecutive time periods of equal time period length of a time curve of a value of the signal strength of the detected ultrasonic echo signal.

21. Apparatus according to claim 20, wherein the memory and the program instructions are further configured, together with the at least one processor, to prompt the apparatus to perform:
determining a graphic representation of the ultrasonic echo signal data at least partly as a function of the ultrasonic echo signal data blocks.
